(19) United States
(12) Patent Application Publication
(10) Pub. No.: US 2019/0220883 A1
(43) Pub. Date: Jul. 18, 2019

(54) SYSTEMS TO ENCOURAGE USER PICK-UP OVER HOME DELIVERY OF AN ITEM MADE AVAILABLE AND RELATED METHODS THEREFOR

(71) Applicant: Walmart Apollo, LLC, Bentonville, AR (US)

(72) Inventors: Marc Eric Lore, Mountain Lakes, NJ (US); Jatin Pahuja, San Bruno, CA (US); Stephen Menaquale, South San Francisco, CA (US); Alexander Fu, Brooklyn, NY (US); Hiren Patel, Pleasanton, CA (US); Brandon Strong, San Bruno, CA (US); Jordan Sweetnam, Los Gatos, CA (US); Yang Tang, Redwood City, CA (US); Nathan Thomas Faust, Chatham, NJ (US); Zachary Dennett, New York, NY (US); Julia Lu, San Francisco, CA (US)

(73) Assignee: Walmart Apollo, LLC, Bentonville, AR (US)

(21) Appl. No.: 16/250,944

(22) Filed: Jan. 17, 2019

Related U.S. Application Data
(60) Provisional application No. 62/618,456, filed on Jan. 17, 2018.

(51) Int. Cl. G06Q 30/02; G06Q 30/06; G06Q 10/08

(52) U.S. Cl. CPC G06Q 30/0222; G06Q 30/0641; G06Q 10/08345; G06Q 30/0635

(57) ABSTRACT

Some embodiments include a system to encourage user pick-up over home delivery of an item being made available to a user for purchase. The system can comprise one or more processors and/or one or more non-transitory memory storage devices. The one or more memory storage devices can store computer instructions configured to run on the one or more processors and perform acts of: causing the item to be displayed on a graphical user interface; and when the item is to be received by the user by user pick-up, evaluating whether the item is eligible to be made available for purchase at a user pick-up discounted retail price that is less than a home delivery retail price at which the item is made available for purchase when the item is to be received by the user by home delivery. Other embodiments of related systems and methods are also provided.

### CROSS REFERENCES TO RELATED APPLICATIONS

This application claims the benefit of U.S. Provisional Patent Application No. 62/618,456, which is herein incorporated by reference in its entirety.

### TECHNICAL FIELD

This disclosure is generally related to graphical user interfaces and more specifically to graphical user interfaces that incentivize users to choose in-store pick-up of items.

### BACKGROUND

Many modern companies are beginning to blend their online offerings with their brick-and-mortar location offerings. One way this blending is occurring is to allow for in-store pick-up of items ordered over the internet. This in-store pick-up poses a number of challenges, though. First, how does a company best structure a graphical user interface (“GUI”) to incentivize a user to choose in-store pick-up? Second, how does a company structure a back end of this GUI system?

### BRIEF DESCRIPTION OF THE DRAWINGS

To facilitate further description of the embodiments, the following drawings are provided in which:

FIG. 1 illustrates a front elevational view of an exemplary computer system that is suitable to implement at least part of a central computer system, at least part of one or more user computer systems, and/or at least part of one or more third party computer systems of the system of FIG. 3, and/or to implement at least part of one or more of the activities of the method of FIG. 8 or one or more other methods described herein;

FIG. 2 illustrates a representative block diagram of exemplary elements included on the circuit boards inside a chassis of the computer system of FIG. 1;

FIG. 3 illustrates a representative block diagram of a system, according to an embodiment;

FIG. 4 illustrates a representative block diagram of a central computer system of the system of FIG. 3, according to the embodiment of FIG. 3;

FIG. 5 illustrates a representative block diagram of one or more databases of the system of FIG. 3, according to the embodiment of FIG. 3;

FIG. 6 illustrates a flow chart for a method of providing a system, according to an embodiment;

FIG. 7 illustrates a flow chart for an exemplary activity of providing a central computer system, according to the embodiment of FIG. 6;

FIG. 8 illustrates a flow chart for an embodiment of a method;

FIG. 9 illustrates a flow chart for an exemplary activity of, when an item is to be received by a user by user pick-up, evaluating whether the item is eligible, to be made available for purchase at a user pick-up discounted retail price that is less than a home delivery retail price at which the item is made available for purchase when the item is to be received by the user by home delivery, according to the embodiment of FIG. 8; and

FIG. 10 illustrates a flow chart for an exemplary activity of determining the user pick-up discounted retail price, according to the embodiment of FIG. 8;

FIGS. 11A-H illustrate internet graphical user interfaces according to various embodiments; and

FIGS. 12A-E illustrate mobile internet graphical user interfaces according to various embodiments;

FIGS. 13A-E illustrate mobile application graphical user interfaces according to various embodiments; and

FIG. 14 illustrates a mobile graphical user interface according to an alternate embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DETAILED DESCRIPTION OF EXAMPLES OF EMBODIMENTS

Some embodiments can include a system to encourage user pick-up over home delivery of an item being made available to a user for purchase. The system can comprise one or more processors and/or one or more non-transitory memory storage devices. The one or more memory storage devices can store computer instructions congfigured to run on the one or more processors and perform acts of: causing the item to be displayed on a graphical user interface; and when the item is to be received by the user by user pick-up, evaluating whether the item is eligible to be made available for purchase at a user pick-up discounted retail price that is less than a home delivery retail price at which the item is made available for purchase when the item is to be received by the user by home delivery.

Many embodiments can include a method to encourage user pick-up over home delivery of an item being made available to a user for purchase. The method can be implement via execution of computer instructions configured to run at one or more processors and configured to be stored at one or more non-transitory memory storage devices. The method can comprise: causing the item to be displayed on a graphical user interface; and when the item is to be received by the user by user pick-up, evaluating whether the item is eligible to be made available for purchase at a user pick-up discounted retail price that is less than a home delivery retail price at which the item is made available for purchase when the item is to be received by the user by home delivery.

Various embodiments can include a system to encourage user pick-up over home delivery of an item being made available to a user for purchase. The system can comprise one or more processors and/or one or more non-transitory memory storage devices. The one or more memory storage devices can store computer instructions configured to run on the one or more processors and perform acts of: causing the item to be displayed on a graphical user interface; and when the item is to be received by the user by user pick-up, evaluating whether the item is eligible to be made available for purchase at a user pick-up discounted retail price that is less than a home delivery retail price at which the item is made available for purchase when the item is to be received by the user by home delivery; after evaluating that the item is eligible, determining the user pick-up discounted retail price; and causing the graphical user interface to display at least one of the user pick-up discounted retail price or a difference of the home delivery retail price and the user pick-up discounted retail price; wherein: evaluating whether the item is eligible, when the item is to be received by the user by user pick-up, to be made available for purchase at the user pick-up discounted retail price that is less than the home delivery retail price at which the item is made available for purchase when the item is to be received by the user by home delivery can comprise: evaluating whether the item is eligible to be received by the user by user pick-up; evaluating whether the item is subject to a minimum advertised price limitation; or evaluating whether the item is subject to store sharing; and determining the user pick-up discounted retail price can comprise: calculating a package shipping cost savings as a difference in a cost to ship by home delivery a package containing the item and a cost to ship by store delivery the package containing the item; calculating a unit shipping cost savings as a quotient of the package shipping cost savings and a units per package value associated with the item; calculating a user pick-up discount as a product of the unit shipping cost savings and a predetermined discount percentage; assigning a first limited user pick-up discount as a product of the home delivery retail price and a predetermined maximum retail percentage; assigning a second limited user pick-up discount as a predetermined maximum discount; and assigning the user pick-up discounted retail price as a difference of the home delivery retail price and a lowest value of the user pick-up discount, the first limited user pick-up discount, and the second limited user pick-up discount.

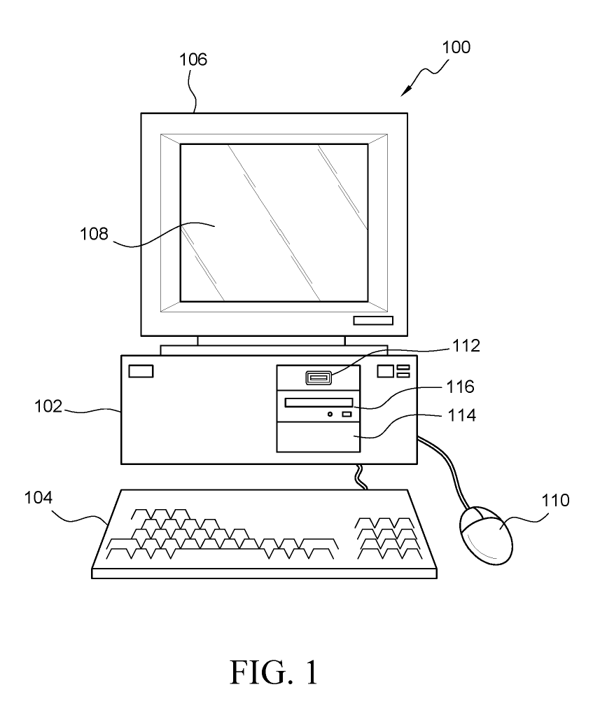

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage devices described herein. For example, in some embodiments, all or a portion of computer system 100 can be suitable for implementing part or all of one or more embodiments of the techniques, methods, and/or systems described herein. Furthermore, one or more elements of computer system 100 (e.g., a refreshing monitor 106, a keyboard 104, and/or a mouse 110, etc.) also can be appropriate for implementing part or all of one or more embodiments of the techniques, methods, and/or systems described herein.

In many embodiments, computer system 100 can comprise chassis 102 containing one or more circuit boards (not shown), a Universal Serial Bus (USB) port 112, a hard drive 114, and an optical disc drive 116. Meanwhile, for example, optical disc drive 116 can comprise a Compact Disc Read-Only Memory (CD-ROM), a Digital Video Disc (DVD) drive, or a Blu-ray drive. Still, in other embodiments, a different or separate one of a chassis 102 (and its internal components) can be suitable for implementing part or all of one or more embodiments of the techniques, methods, and/or systems described herein.

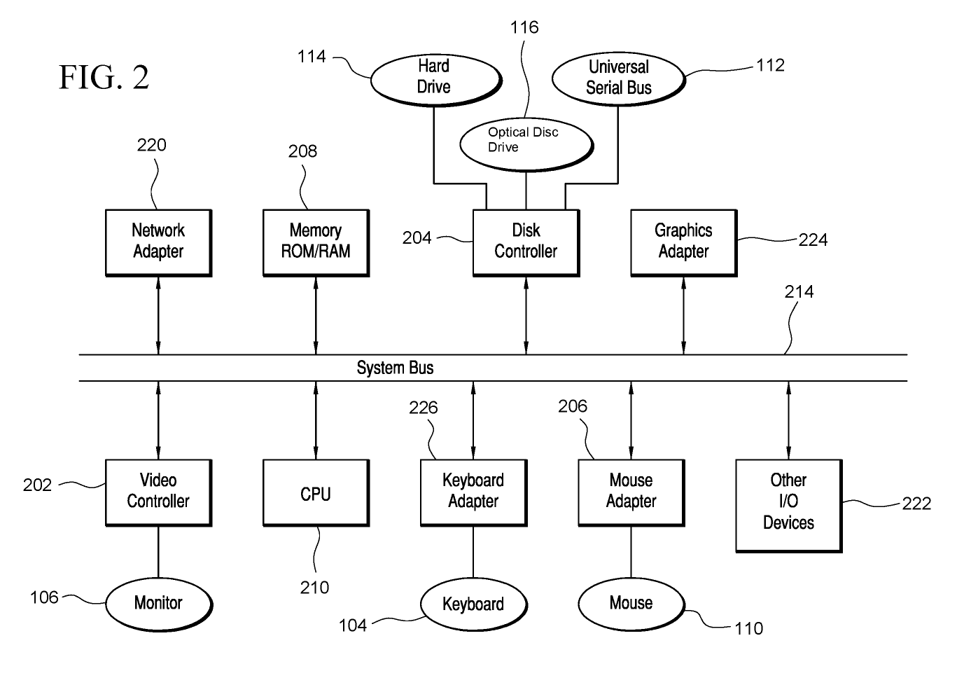

Turning ahead in the drawings, FIG. 2 illustrates a representative block diagram of exemplary elements included on the circuit boards inside chassis 102 (FIG. 2). For example, a central processing unit (CPU) 210 is coupled to a system bus 214. In various embodiments, the architecture of CPU 210 can be compliant with any of a variety of commercially distributed architecture families.

In many embodiments, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

The memory storage device(s) of the various embodiments disclosed herein can comprise memory storage unit 208, an external memory storage drive (not shown), such as, for example, a USB-equipped electronic memory storage drive coupled to universal serial bus (USB) port 112 (FIGS. 1 & 2), hard drive 114 (FIGS. 1 & 2), optical disc drive 116 (FIGS. 1 & 2), a floppy disk drive (not shown), etc. As used herein, non-volatile and/or non-transitory memory storage device(s) refer to the portions of the memory storage device(s) that are non-volatile and/or non-transitory memory.

In various examples, portions of the memory storage device(s) of the various embodiments disclosed herein (e.g., portions of the non-volatile memory storage device(s)) can be encoded with a boot code sequence suitable for restoring computer system 100 (FIG. 1) to a functional state after a system reset. In addition, portions of the memory storage device(s) of the various embodiments disclosed herein (e.g., portions of the non-volatile memory storage device(s)) can comprise microcode such as a Basic Input-Output System (BIOS) or Unified Extensible Firmware Interface (UEFI) operable with computer system 100 (FIG. 1). In the same or different examples, portions of the memory storage device(s) of the various embodiments disclosed herein (e.g., portions of the non-volatile memory storage device(s)) can comprise an operating system, which can be a software program that manages the hardware and software resources of a computer and/or a computer network. Meanwhile, the operating system can perform basic tasks such as, for example, controlling and allocating memory, prioritizing the processing of instructions, controlling input and output devices, facilitating networking, and managing files. Exemplary operating systems can comprise (i) Microsoft® Windows® operating system (OS) by Microsoft Corp. of Redmond, Wash., United States of America, (ii) Mac® OS by Apple Inc. of Cupertino, Calif., United States of America, (iii) UNIX® OS, and (iv) Linux® OS. Further exemplary operating systems can comprise (i) iOS™ by Apple Inc. of Cupertino, Calif., United States of America, (ii) the Blackberry® OS by Research In Motion (RIM) of Waterloo, Ontario, Canada, (iii) the Android™ OS developed by the Open Handset Alliance, or (iv) the Windows Mobile™ OS by Microsoft Corp. of Redmond, Wash., United States of America. Further, as used herein, the term “computer network” can refer to a collection of computers and devices interconnected by communications channels that facilitate communications among users and allow users to share resources (e.g., an internet connection, an Ethernet connection, etc.). The computers and devices can be interconnected according to any conventional network topology (e.g., bus, star, tree, linear, ring, mesh, etc.).

As used herein, the term “processor” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1 & 2) and mouse 110 (FIGS. 1 & 2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1 & 2) to display images on a screen 108 (FIG. 1) of computer system 100 (FIG. 1). Disk controller 204 can control hard drive 114 (FIGS. 1 & 2), USB port 112 (FIGS. 1 & 2), and CD-ROM drive 116 (FIGS. 1 & 2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage device(s) of the various embodiments disclosed herein can be executed by CPU 210 (FIG. 2). At least a portion of the program instructions, stored on these devices, can be suitable for carrying out at least part of the techniques, methods, and activities of the methods described herein. In various embodiments, computer system 100 can be reprogrammed with one or more systems, applications, and/or databases to convert computer system 100 from a general purpose computer to a special purpose computer.

Further, although computer system 100 is illustrated as a desktop computer in FIG. 1, in many examples, system 100 can have a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a mobile device. In certain additional embodiments, computer system 100 may comprise an embedded system.

As used herein, the term “mobile device” can refer to a portable electronic device (e.g., an electronic device easily conveyable by hand by a person of average size) with the capability to present audio and/or visual data (e.g., text, images, videos, music, etc.). For example, a mobile device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable computer device, or another portable computer device with the capability to present audio and/or visual data (e.g., text, images, videos, music, etc.).

In many examples, a mobile device can comprise a volume and/or weight sufficiently small as to permit the mobile device to be easily conveyable by hand. For example, in some embodiments, a mobile device can occupy a volume of less than or equal to approximately 189 cubic centimeters, 244 cubic centimeters, 1790 cubic centimeters, 2434 cubic centimeters, 2876 cubic centimeters, 4016 cubic centimeters, and/or 5752 cubic centimeters. Further, in these embodiments, a mobile device can weigh less than or equal to 3.24 Newtons, 4.35 Newtons, 15.6 Newtons, 17.8 Newtons, 22.3 Newtons, 31.2 Newtons, and/or 44.5 Newtons.

Exemplary mobile devices can comprise, but are not limited to, one of the following: (i) an iPod®, iPhone®, iPod Touch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia®, Surface Pro™, or similar product by the Microsoft Corporation of Redmond, Wash., United States of America, and/or (iv) a Galaxy™, Galaxy Tab™, Note™, or similar product by the Samsung Group of Samsung Town, Seoul, South Korea. Further, in the same or different embodiments, a mobile device can comprise an electronic device configured to implement one or more of (i) iOS™ by Apple Inc. of Cupertino, Calif., United States of America, (ii) Blackberry® OS by Research In Motion (RIM) of Waterloo, Ontario, Canada, (iii) Android™ OS developed by the Open Handset Alliance, or (iv) Windows Mobile™ OS by Microsoft Corp. of Redmond, Wash., United States of America.

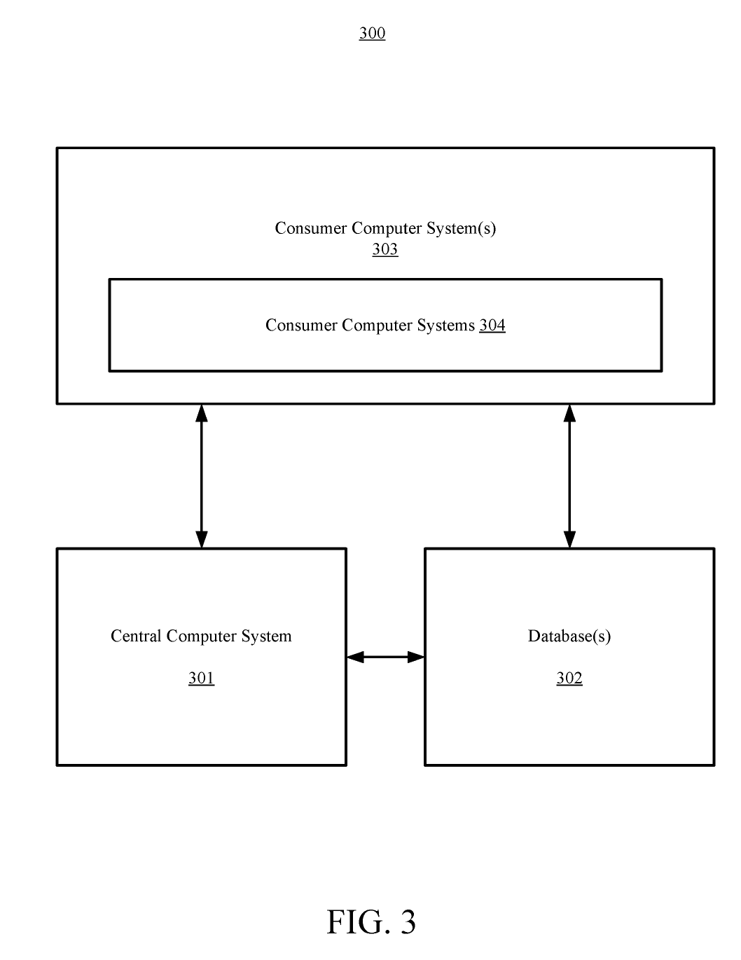

Skipping ahead now in the drawings, FIG. 3 illustrates a representative block diagram of a system 300, according to an embodiment. In many embodiments, system 300 can comprise a computer system. In some embodiments, system 300 can be implemented to perform part or all of one or more methods (e.g., method 700 (FIG. 7)).

System 300 is merely exemplary and embodiments of the system are not limited to the embodiments presented herein. System 300 can be employed in many different embodiments or examples not specifically depicted or described herein. In some embodiments, certain elements of system 300 can perform various methods and/or activities of those methods. In these or other embodiments, the methods and/or the activities of the methods can be performed by other suitable elements of system 300.

As explained in greater detail below, in many embodiments, system 300 is operable to encourage user pick-up over home delivery of one or more items being made available to one or more users for purchase. In order to encourage user pick-up over home delivery of item(s) being made available to user(s) for purchase, system 300 can make available the item(s) for purchase at one or more user pick-up discounted retail prices when the item(s) are to be received by the user by user pick-up that are lower than one or more home delivery retail prices when the item(s) are to be received by the user by home delivery. For example in some embodiments, system 300 can pass on to the user(s) part or all of a cost savings of an entity making available the item(s) to the user(s) for purchase as a result of the user(s) receiving the item(s) by user pick-up rather than home delivery.

Accordingly as also explained in greater detail below, in many embodiments, implementing system 300 advantageously can allow an entity making available item(s) to user(s) for purchase to save costs that would result from the user(s) receiving the item(s), when purchased, by home delivery. For example, when item(s) are received by user(s) by user pick-up rather than home delivery, the entity making available the item(s) to the user(s) for purchase may benefit from the cost savings of transporting the item(s) over shorter distances. Additionally, when item(s) are received by user(s) by user pick-up rather than home delivery, the entity making available the item(s) to the user(s) for purchase may benefit from time and cost efficiencies of being able to transport the item(s) with greater density, particularly when item(s) purchased by multiple users can be packaged together.

Generally, therefore, system 300 can be implemented with hardware and/or software, as described herein. In some embodiments, at least part of the hardware and/or software can be conventional, while in these or other embodiments, part or all of the hardware and/or software can be customized (e.g., optimized) for implementing part or all of the functionality of system 300 described herein.

Specifically, system 300 can comprise a central computer system 301. In many embodiments, central computer system 301 can be similar or identical to computer system 100 (FIG. 1). Accordingly, central computer system 301 can comprise one or more processors and one or more memory storage devices (e.g., one or more non-transitory memory storage devices). In these or other embodiments, the processor(s) and/or the memory storage device(s) can be similar or identical to the processor(s) and/or memory storage device(s) (e.g., non-transitory memory storage devices) described above with respect to computer system 100 (FIG. 1). In some embodiments, central computer system 301 can comprise a single computer or server, but in many embodiments, central computer system 301 comprises a cluster or collection of computers or servers and/or a cloud of computers or servers. Further, in these or other embodiments, central computer system 301 can be implemented with a distributed network comprising a distributed memory architecture. The distributed memory architecture can reduce the impact on the distributed network and system resources to reduce congestion in bottlenecks while still allowing data to be accessible from a central location.

Meanwhile, central computer system 301 can comprise one or more input devices (e.g., one or more keyboards, one or more keypads, one or more pointing devices such as a computer mouse or computer mice, one or more touchscreen displays, etc.), and/or can comprise one or more output devices (e.g., one or more monitors, one or more touch screen displays, one or more speakers, etc.). Accordingly, the input device(s) can comprise one or more devices configured to receive one or more inputs, and/or the output device(s) can comprise one or more devices configured to provide (e.g., present, display, emit, etc.) one or more outputs. For example, in these or other embodiments, one or more of the input device(s) can be similar or identical to keyboard 104 (FIG. 1) and/or a mouse 110 (FIG. 1). Further, one or more of the output device(s) can be similar or identical to refreshing monitor 106 (FIG. 1) and/or screen 108 (FIG. 1). The input device(s) and the output device(s) can be coupled to the processor(s) and/or the memory storage device(s) of central computer system 301 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the output device(s) to the processor(s) and/or the memory storage device(s). In some embodiments, the KVM switch also can be part of central computer system 301. In a similar manner, the processor(s) and the memory storage device(s) can be local and/or remote to each other.

In many embodiments, central computer system 301 is configured to communicate with user computer systems 303 of multiple users. For example, the user(s) can interface (e.g., interact) with central computer system 301, and vice versa, via user computer systems 303.

In these or other embodiments, user computer systems 303 can comprise user computer system 304. In some embodiments, system 300 can comprise one or more of user computer systems 303.

In many embodiments, central computer system 301 can refer to a back end of system 300 operated by an operator and/or administrator of system 300. In these or other embodiments, the operator and/or administrator of system 300 can manage central computer system 301, the processor(s) of central computer system 301, and/or the memory storage device(s) of central computer system 301 using the input device(s) and/or output device(s) of central computer system 301.

Like central computer system 301, user computer systems 303 each can be similar or identical to computer system 100 (FIG. 1), and in many embodiments, multiple or all of user computer systems 303 can be similar or identical to each other. In many embodiments, user computer systems 303 can comprise one or more desktop computer devices and/or one or more mobile devices, etc. At least part of central computer system 301 can be located remotely from user computer systems 303.

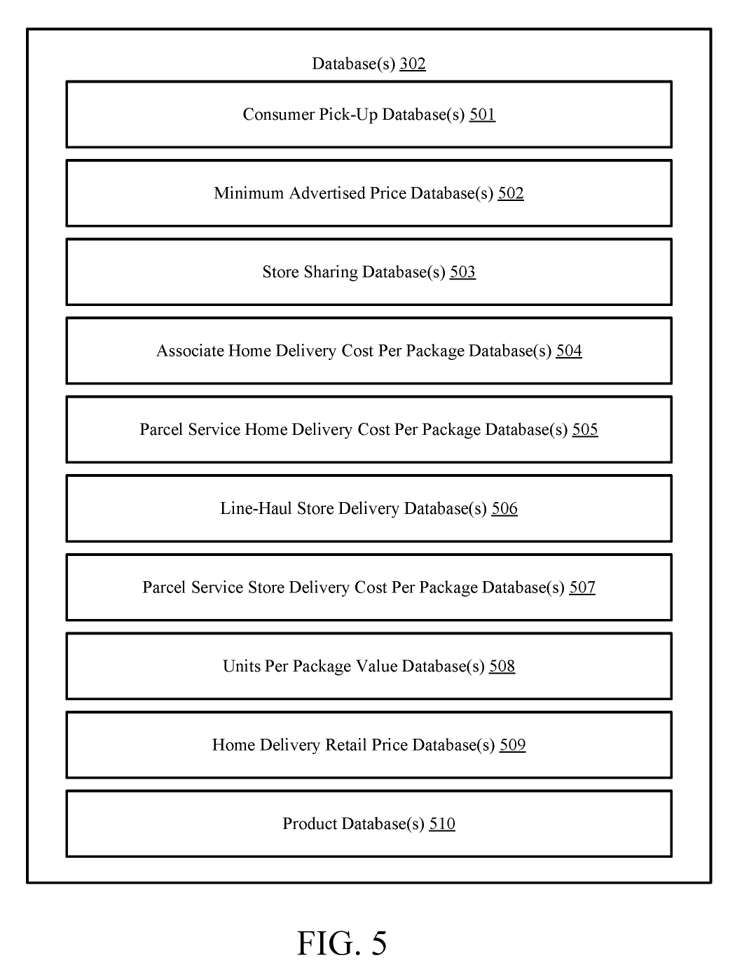

Meanwhile, in many embodiments, for reasons explained later herein, central computer system 301 also can be configured to communicate with one or more databases 302 (e.g., one or more user pick-up databases 501 (FIG. 5), one or more minimum advertised price databases 502 (FIG. 5), one or more store sharing databases 503, one or more associate home delivery cost per package databases 504, one or more parcel service home delivery cost per package databases 505, one or more line-haul store delivery cost per package databases 506, one or more parcel service store delivery cost per package databases 507, one or more units per package value databases 508, one or more home delivery retail price databases 509, one or more item databases 510, etc.). Database(s) 302 can be stored on one or more memory storage devices (e.g., non-transitory memory storage device(s)), which can be similar or identical to the one or more memory storage device(s) (e.g., non-transitory memory storage device(s)) described above with respect to computer system 100 (FIG. 1). Also, in some embodiments, for any particular database of database(s) 302, that particular database can be stored on a single memory storage device of the memory storage device(s) and/or the non-transitory memory storage device(s) storing database(s) 302 or it can be spread across multiple of the memory storage device(s) and/or non-transitory memory storage device(s) storing database(s) 302, depending on the size of the particular database and/or the storage capacity of the memory storage device(s) and/or non-transitory memory storage device(s).

In these or other embodiments, the memory storage device(s) of central computer system 301 can comprise some or all of the memory storage device(s) storing database(s) 302. In further embodiments, some of the memory storage device(s) storing database(s) 302 can be part of one or more of user computer systems 303 and/or one or more third-party computer systems (i.e., other than central computer system 301 and/or user computer systems 303), and in still further embodiments, all of the memory storage device(s) storing database(s) 302 can be part of one or more of user computer systems 303 and/or one or more of the third-party computer system(s). Like central computer system 301 and/or user computer systems 303, when applicable, each of the third-party computer system(s) can be similar or identical to computer system 100 (FIG. 1). For simplicity and clarity of illustration, the third-party computer systems are not shown at FIG. 3, and database(s) 302 are illustrated at FIG. 3 apart from central computer system 301 and user computer systems 303 to better illustrate that database(s) 302 can be stored at memory storage device(s) of central computer system 301, user computer systems 303, and/or the third-party computer system(s), depending on the manner in which system 300 is implemented.

Database(s) 302 each can comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database and IBM DB2 Database.

Meanwhile, communication between central computer system 301, user computer systems 303, the third-party computer system(s), and/or database(s) 302 can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), Powerline network protocol(s), etc.). Exemplary PAN protocol(s) can comprise Bluetooth, Zigbee, Wireless Universal Serial Bus (USB), Z-Wave, etc. Exemplary LAN and/or WAN protocol(s) can comprise Data Over Cable Service Interface Specification (DOCSIS), Institute of Electrical and Electronic Engineers (IEEE) 802.3 (also known as Ethernet), IEEE 802.11 (also known as WiFi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

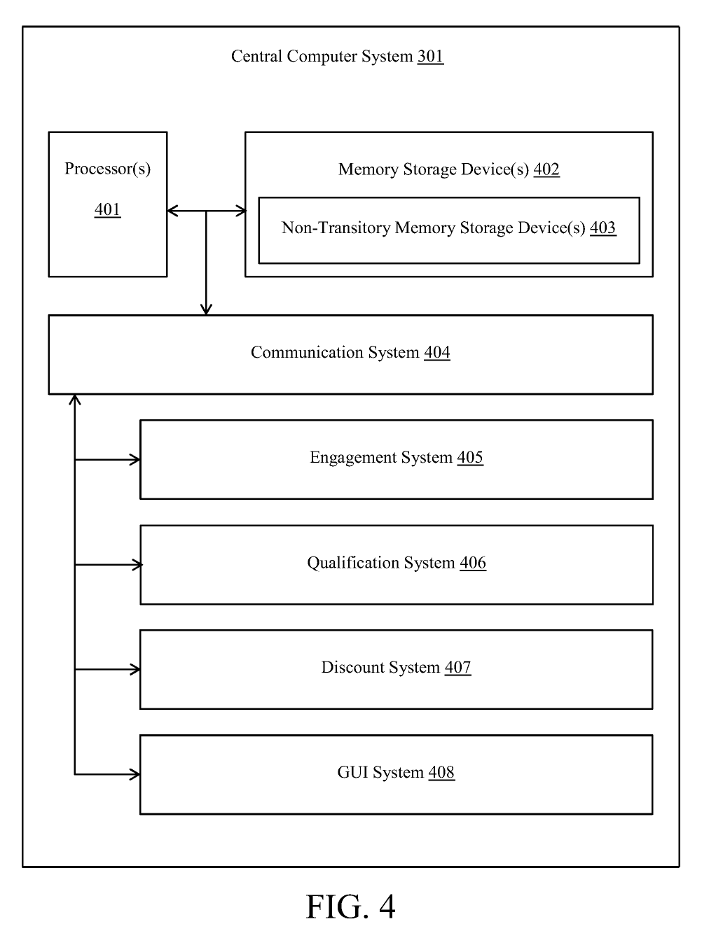

Turning ahead now in the drawings, FIG. 4 illustrates a representative block diagram of central computer system 301, according to the embodiment of FIG. 3; and FIG. 5 illustrates a representative block diagram of database(s) 302, according to the embodiment of FIG. 3.

Referring to FIG. 4, in many embodiments, central computer system 301 can comprise one or more processors 401 and one or more memory storage devices 402. Further, memory storage device(s) 402 can comprise one or more non-transitory memory storage devices 403.

Meanwhile, in these or other embodiments, central computer system 301 comprises a communication system 404, an engagement system 405, a qualification system 406, a discount system 407, and/or a GUI system 408. In these or other embodiments, part or all of at least one or more of communication system 404, engagement system 405, qualification system 406, discount system 407, and/or GUI system 408 can be part of at least one or more others of communication system 404, engagement system 405, qualification system 406, discount system 407, and/or GUI system 408, and vice versa.

In many embodiments, processor(s) 401 can be similar or identical to the processor(s) described above with respect to computer system 100 (FIG. 1) and/or central computer system 301 (FIG. 3); memory storage device(s) 402 can be similar or identical to the memory storage device(s) described above with respect to computer system 100 (FIG. 1) and/or central computer system 301 (FIG. 3); and/or non-transitory memory storage device(s) 403 can be similar or identical to the non-transitory memory storage device(s) described above with respect to computer system 100 (FIG. 1) and/or central computer system 301 (FIG. 3). Further, communication system 404, engagement system 405, qualification system 406, discount system 407, and/or GUI system 408 can be implemented with hardware and/or software, as desirable. Although communication system 404, engagement system 405, qualification system 406, discount system 407, and/or GUI system 408 are shown at FIG. 4 as being separate from processor(s) 401, memory storage device(s) 402, and/or non-transitory memory storage device(s) 403, in many embodiments, part or all of communication system 404, engagement system 405, qualification system 406, discount system 407, and/or GUI system 408 can be stored at memory storage device(s) 402 and/or non-transitory memory storage device(s) 403 and can be called and run at processor(s) 401, such as, for example, when the part or all of communication system 404, engagement system 405, qualification system 406, discount system 407, and/or GUI system 408 are implemented as software.

Communication system 404 can provide and manage communication between the various elements of central computer system 301 (e.g., processor(s) 401, memory storage device(s) 402, non-transitory memory storage device(s) 403, engagement system 405, qualification system 406, discount system 407, and/or GUI system 408, etc.) and manage incoming and outgoing communications between central computer system 301 (FIG. 3) and user computer systems 303 (FIG. 3), the third party computer system(s), and/or database(s) 302 (FIG. 3). Like the communications between central computer system 301 (FIG. 3), user computer systems 303 (FIG. 3), the third party computer system(s), and/or database(s) 302 (FIG. 3), communication system 404 can be implemented using any suitable manner of wired and/or wireless communication, and/or using any one or any combination of wired and/or wireless communication network topologies and/or protocols, as described above with respect to the central computer system 301 (FIG. 3), user computer systems 303 (FIG. 3), the third party computer system(s), and/or database(s) 302 (FIG. 3). In many embodiments, communication system 404 can be part of hardware and/or software implemented for communications between central computer system 301 (FIG. 3), user computer systems 303 (FIG. 3), the third party computer system(s), and/or database(s) 302 (FIG. 3). For example, as applicable, communication system 404 can permit processor(s) 401 to call (i) software (e.g., at least part of engagement system 405, qualification system 406, discount system 407, and/or GUI system 408, etc.) stored at memory storage device(s) 402 and/or non-transitory memory storage device(s) 403, and/or (ii) data stored at memory storage device(s) 402, at non-transitory memory storage device(s) 403, and/or in database(s) 302 (FIG. 3).

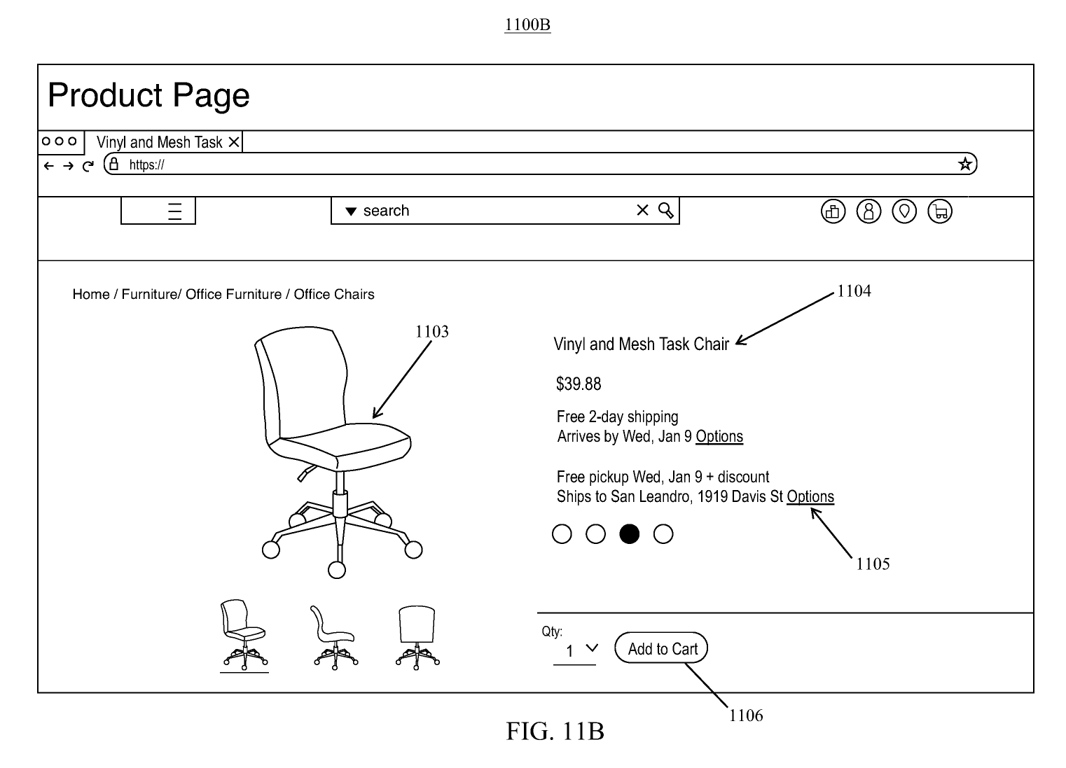

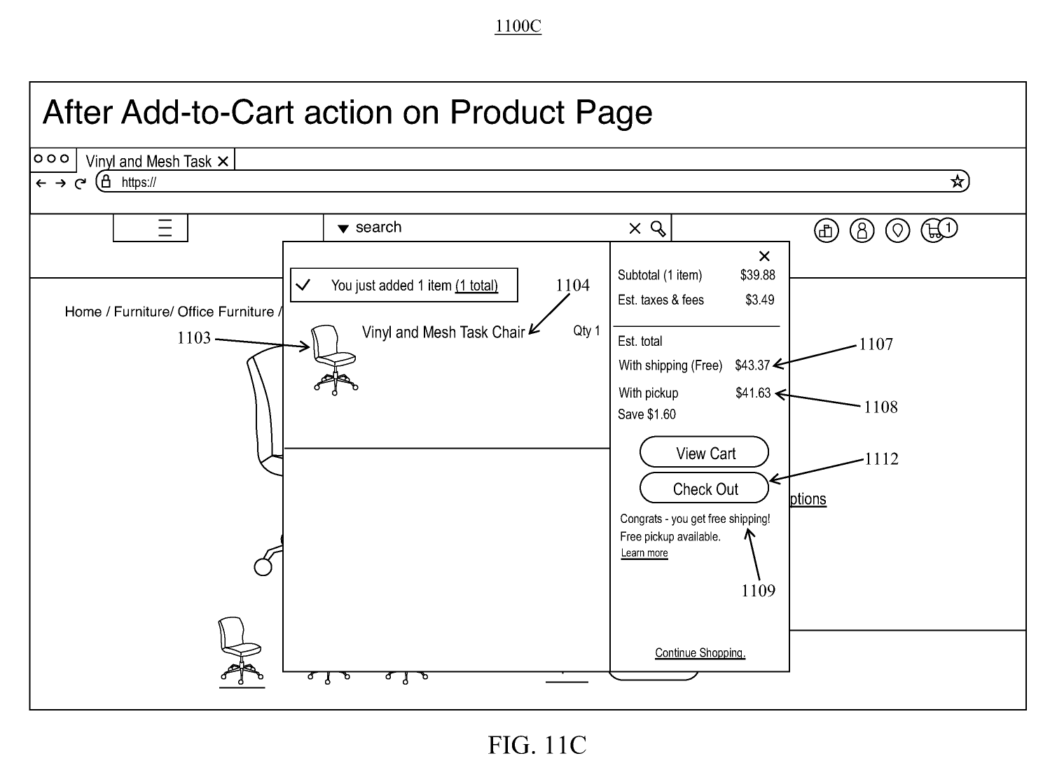

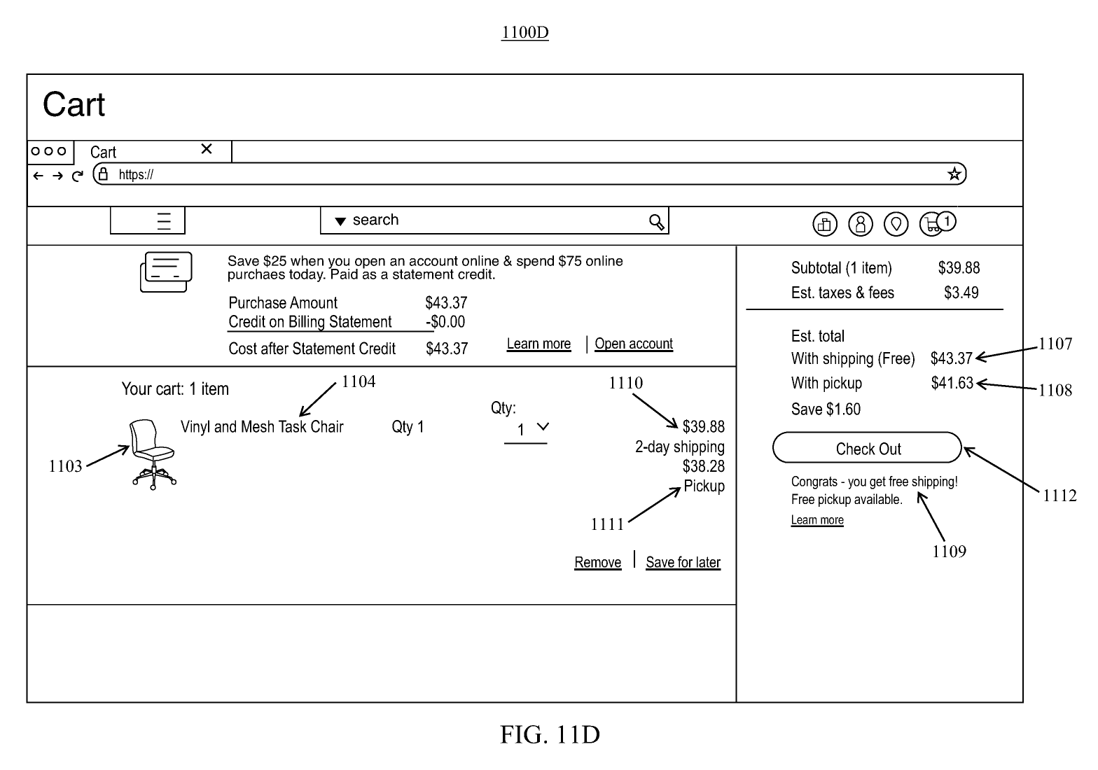

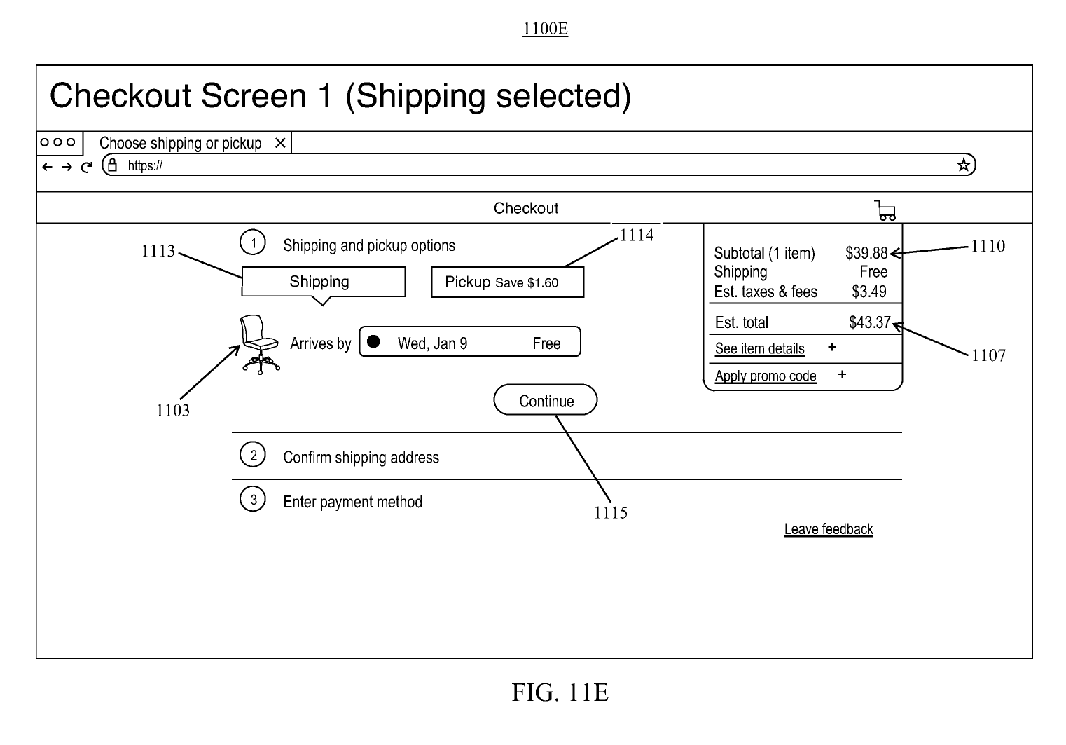

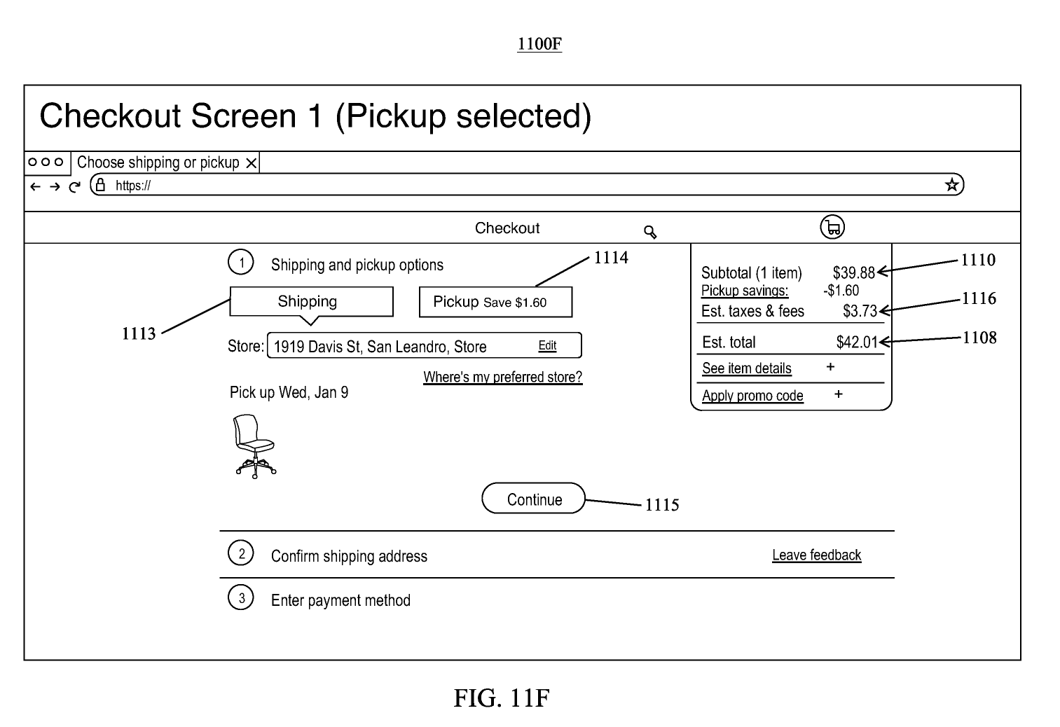

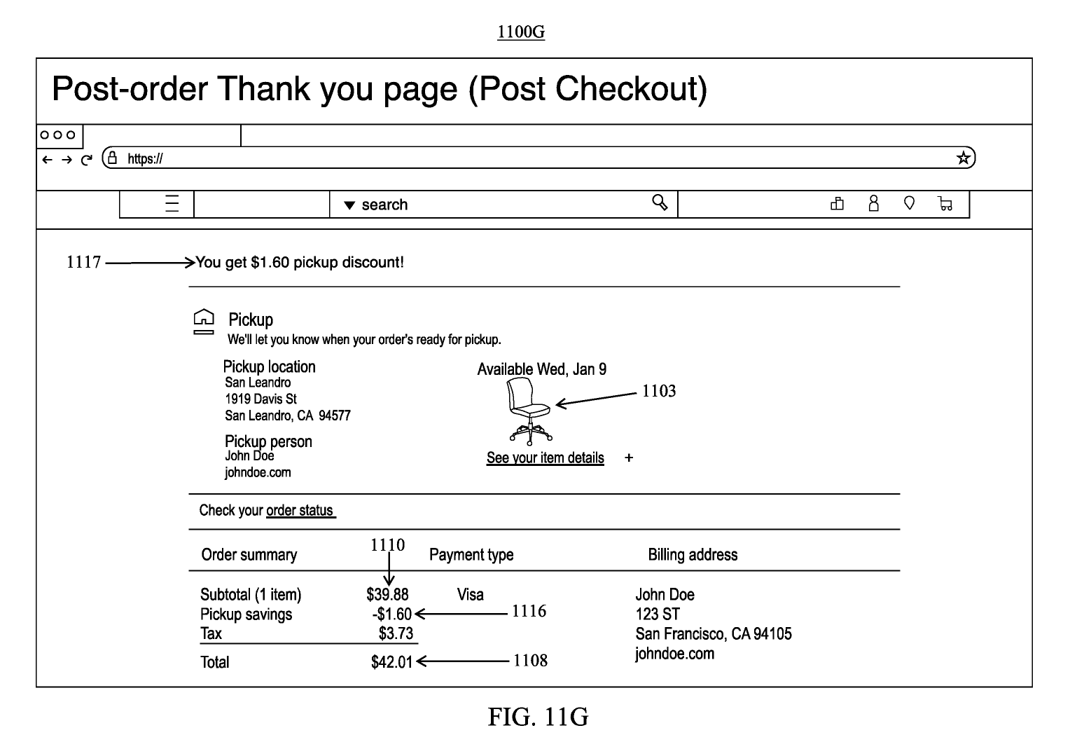

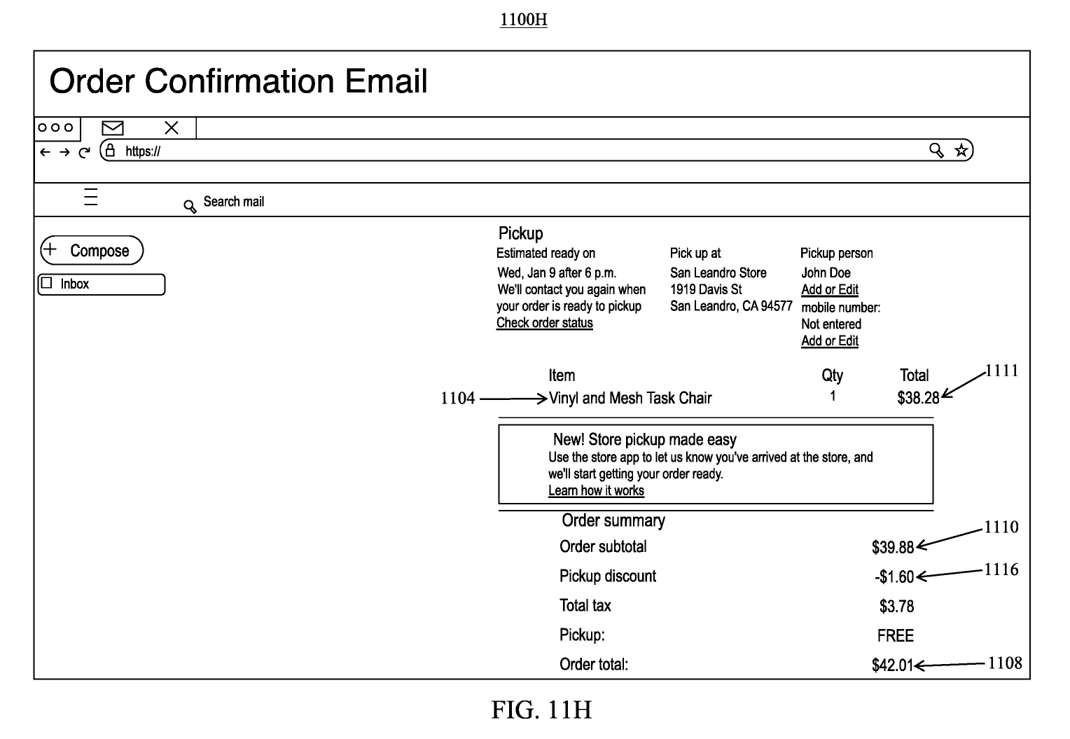

Engagement system 405 can cause an item being made available for purchase by a user to be communicated (e.g., displayed) to the user on a graphical user interface (“GUI”). In many embodiments, the GUI can comprise GUIs shown in FIGS. 11-13. In some embodiments, the entity making available the item for purchase by the user can be the operator of system 300 (FIG. 3) or a third-party for whom the operator of system 300 (FIG. 3) is operating system 300 (FIG. 3).

In many embodiments, engagement system 405 can cause the item being made available for purchase by the user to be communicated to the user via user computer system 304 (FIG. 3). In some of these embodiments, engagement system 405 can instruct user computer system 304 (FIG. 3) to communicate the item being made available for purchase by the user to the user.

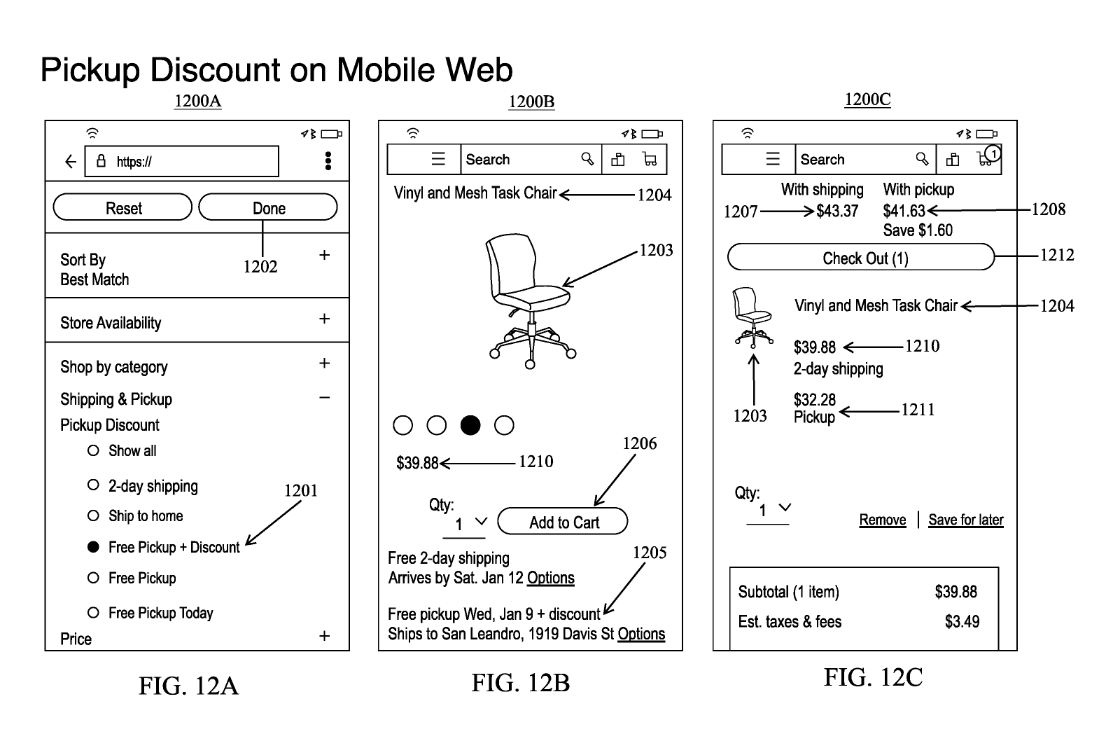

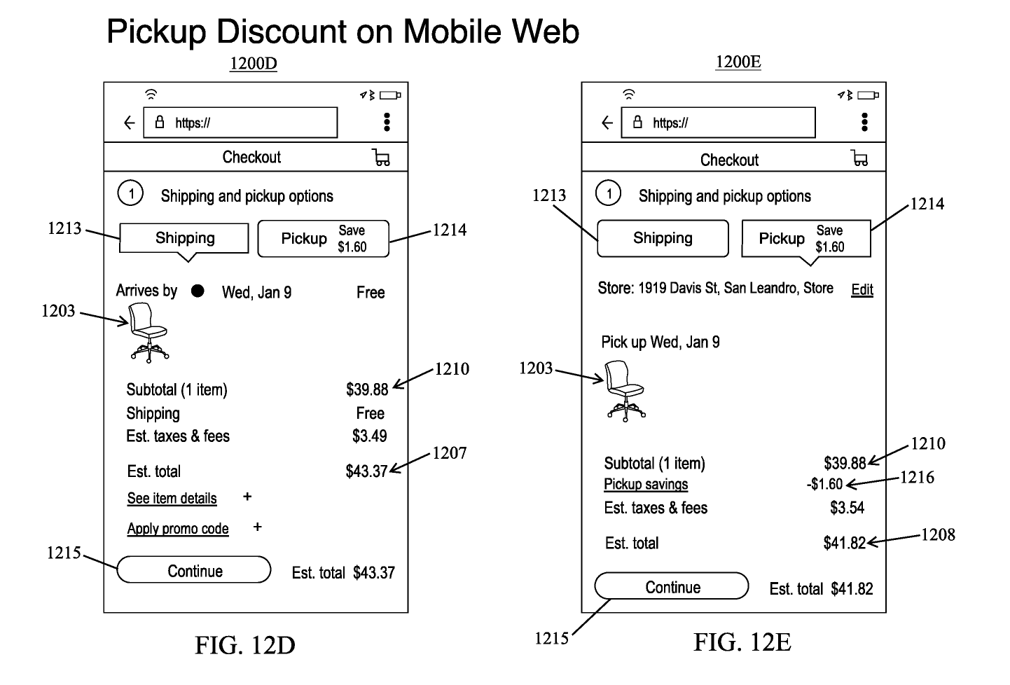

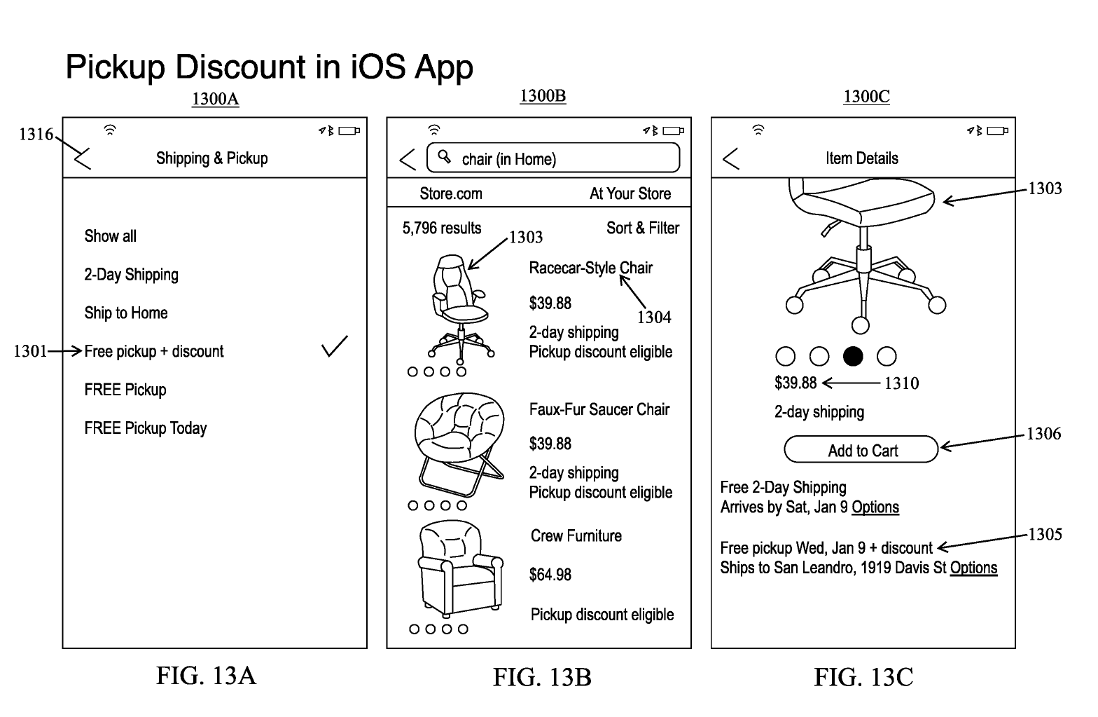

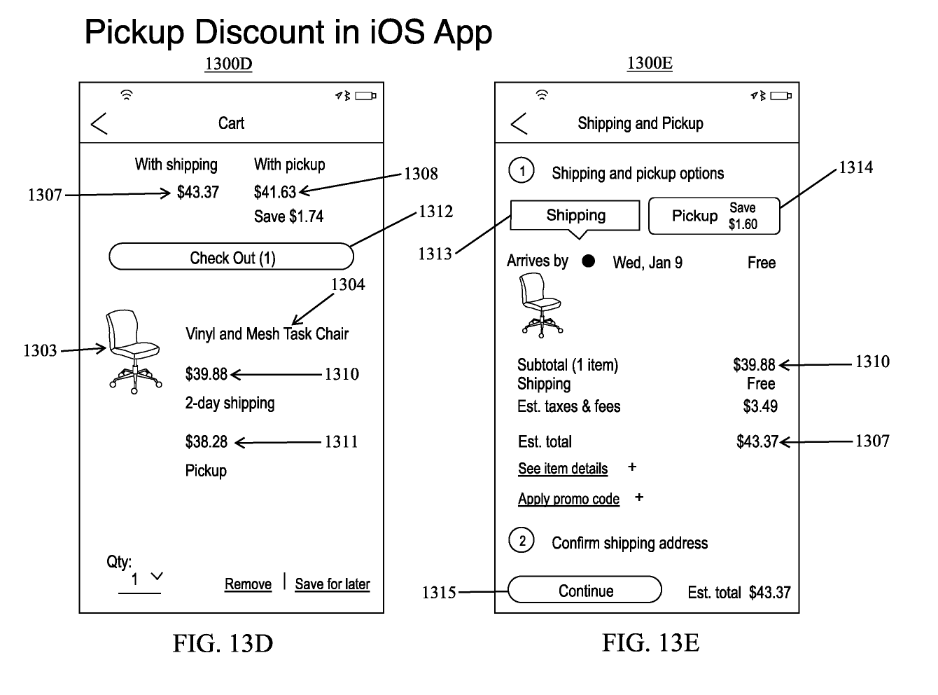

For example, in many embodiments, engagement system 405 can cause the item being made available for purchase by the user to be displayed to the user at user computer system 304 (FIG. 3) on a GUI. In many embodiments, the GUI can comprise GUIs shown in FIGS. 11-13. In these embodiments, the GUI, including the item being made available for purchase by the user, can be displayed on an electronic display of user computer system 304 (FIG. 3). In some embodiments, the GUI can be part of a web page displayed on the electronic display of user computer system 304 (FIG. 3), such as in FIGS. 11A-J. In other embodiments, the GUI can be part of a software application operable on one or more processors and storable on one or more non-transitory memory storage devices of user computer system 304 (FIG. 3). In some of these embodiments, the software application can be a proprietary software application made available to the user for download, such as, for example, by an operator of system 300 (FIG. 3). In various embodiments, the GUI can be optimized to be displayed and/or navigated on a mobile device, such as in FIGS. 12-13.

In many embodiments, the item being made available for purchase by the user also can be made receivable by the user, when the user purchases the item, by user pick-up and/or by home delivery.

In many embodiments, when the item being made available for purchase by the user is made receivable by the user by user pick-up, the item can be delivered to a location maintained by or on behalf of the entity making the item available for purchase (i.e., a user pick-up location) and then the user can pick up the item at the user pick-up location. For example, the user pick-up location can comprise a store, a warehouse, a distribution center, a storage locker, etc. maintained by or on behalf of the entity. In other embodiments, the user pick-up location can exclude a warehouse, a distribution center, and/or a storage locker. As used herein, the term “store delivery” can refer to delivery to the user pick-up location.

In these or other embodiments, the item being made available for purchase by the user can be delivered to the user pick-up location by line-haul store delivery or by parcel store delivery. In some embodiments, the term “line-haul store delivery” can refer to store delivery performed by line-haul shipping. In these or other embodiments, the term “parcel store delivery” can refer to store delivery performed by postal service shipping or by courier service shipping. In other embodiments, parcel store delivery can exclude delivery performed by postal service shipping.

In many embodiments, when the item being made available for purchase by the user is made receivable by the user by home delivery, the item can be delivered to a location other than a location maintained by or on behalf of the entity making the item available for purchase (i.e., a user delivery location). For example, the user delivery location can comprise a location maintained by or on behalf of the user (e.g., a home of the user, an office of the user, etc.) or a location maintained by or on behalf of a third-party (e.g., a home of the third-party, an office of the third-party, etc.). As used herein, the term “home delivery” can refer to delivery to the user delivery location.

In these or other embodiments, the item being made available for purchase by the user can be delivered to the user delivery location by parcel home delivery or by associate home delivery. In some embodiments, the term “parcel home delivery” can refer to home delivery performed by postal service shipping or by courier service shipping. In other embodiments, parcel home delivery can exclude delivery performed by postal service shipping. In these or other embodiments, the term “associate home delivery” can refer to home delivery performed by an employee or a contractor of the entity making available the item for purchase by the user. In some embodiments, the employee or contractor can be affiliated with a location maintained by or on behalf of the entity making the item available for purchase, such as, for example, a store, a warehouse, a distribution center, etc. In further embodiments, the employee or contractor performing delivery to the user pick-up location can exclude a line-haul employee or contractor of the entity making available the item for purchase by the user; and/or a parcel delivery employee or contractor of the entity making available the item for purchase by the user.

In many embodiments, engagement system 405 can cause options for (a) the user to receive by user pick-up the item being made available for purchase by the user to be communicated (e.g., displayed) to the user, and/or (b) the user to receive by home delivery the item being made available for purchase by the user to be communicated (e.g., displayed) to the user. In some of these embodiments, engagement system 405 can instruct user computer system 304 (FIG. 3) to communicate (a) the option for the user to receive by user pick-up the item being made available for purchase by the user to be communicated to the user, and/or (b) the option for the user to receive by home delivery the item being made available for purchase by the user to be communicated to the user.

For example, in many embodiments, engagement system 405 can cause the options (e.g., for the user to receive by user pick-up or home delivery the item being made available for purchase by the user) to be displayed to the user at user computer system 304 (FIG. 3) on the GUI on which the item being made available for purchase is displayed. In these embodiments, the GUI (including (a) the option for the user to receive by user pick-up the item being made available for purchase by the user, and/or (b) the option for the user to receive by home delivery the item being made available for purchase by the user) can be displayed on the electronic display of user computer system 304 (FIG. 3). In many embodiments, the GUI can comprise GUIs described in FIGS. 11-13.

In many embodiments, engagement system 405 can receive a selection of the item being made available for purchase by the user from the user. For example, the user can select the item being made available for purchase by the user to view additional information about the item. In these or other embodiments, engagement system 405 can receive a request from the user to purchase the item being made available for purchase by the user. Further in these or other embodiments, engagement system 405 can receive a selection to receive the item being made available for purchase by the user by user pick-up or a selection to receive the item being made available for purchase by the user by home delivery. In the same or different embodiments, a selection can be made via a GUI displayed on user computer system 304. In various embodiments, the GUI can comprise GUIs described in FIGS. 11-13.

In many embodiments, the user can input (i) the selection of the item being made available for purchase by the user from the user, (ii) the request from the user to purchase the item being made available for purchase by the user, and/or (iii) the selection to receive the item being made available for purchase by the user by user pick-up or the selection to receive the item being made available for purchase by the user by home delivery at user computer system 304 (FIG. 3) via a GUI. In many embodiments, the GUI can comprise GUIs described in FIGS. 11-13. Further, user computer system 304 (FIG. 3) can communicate to engagement system 405 (i) the selection of the item being made available for purchase by the user from the user, (ii) the request from the user to purchase the item being made available for purchase by the user, and/or (iii) the selection to receive the item being made available for purchase by the user by user pick-up or the selection to receive the item being made available for purchase by the user by home delivery.

In many embodiments, engagement system 405 can facilitate providing to the user by user pick-up or by home delivery the item being made available for purchase by the user. For example, engagement system 405 can administer (e.g., schedule, assign, and/or order) providing to the user by user pick-up or by home delivery the item being made available for purchase by the user.

Qualification system 406 can evaluate whether the item being made available for purchase by the user is eligible, when the item is to be received by the user by user pick-up, to be made available for purchase at a user pick-up discounted retail price. The user pick-up discounted retailed price, which can be determined by discount system 407 as explained below, can be less than a home delivery retail price at which the item is made available for purchase when the item is to be received by the user by home delivery. As used herein, the term “retail price” can refer to a price at which an item is made available for purchase by a user before any fees (e.g., tax fees, shipping fees, etc.) are added. Meanwhile, the term “home delivery retail price” can refer to a retail price at which an item is made available for purchase by a user when the item is to be received by the user by home delivery. In many embodiments, when the item being made available for purchase by the user is ineligible, when the item is to be received by the user by user pick-up, to be made available for purchase at the user pick-up discounted retail price, the item being made available for purchase by the user can be made available for purchase at the home delivery retail price.

In many embodiments, in order to evaluate whether the item being made available for purchase by the user is eligible, when the item is to be received by the user by user pick-up, to be made available for purchase at a user pick-up discounted retail price, qualification system 406 can evaluate whether the item is eligible to be received by the user by user pick-up. For example, in these embodiments, when qualification system 406 determines that the item is ineligible to be received by the user by user pick-up, qualification system 406 can also determine that the item being made available for purchase by the user is ineligible, when the item is to be received by the user by user pick-up, to be made available for purchase at the user pick-up discounted retail price.

In some embodiments, qualification system 406 can reference (e.g., query) user pick-up database(s) 501 to evaluate whether the item is eligible to be received by the user by user pick-up. User pick-up database(s) 501 can store an index having a first set of fields identifying items being made available for purchase by the user, including the item being evaluated by qualification system 406, and a second set of fields corresponding to the first set of fields and identifying whether the items of the first set of fields are eligible or ineligible for user pick-up. In these or other embodiments, user pick-up database(s) 501 can be updated from time to time, when applicable, to add or remove items and/or to modify the eligibility of the items for user pick-up.

In these or other embodiments, the entity making available the item for purchase by the user or the operator of system 300 (FIG. 3) can designate whether or not the item is eligible for user pick-up. For example, in some embodiments, the item being made available for purchase by the user can be designated as ineligible for user pick-up when the item is an oversized item and/or a hazardous item. As used herein, the term “oversized item” can refer to an item that exceeds a predetermined maximum dimension, volume, and/or weight, and the term “hazardous item” can refer to an item that exceeds a predetermined level of risk of harming a person exposed to the item.

In many embodiments, in order to evaluate whether the item being made available for purchase by the user is eligible, when the item is to be received by the user by user pick-up, to be made available for purchase at a user pick-up discounted retail price, qualification system 406 can evaluate whether the item is subject to a minimum advertised price limitation. For example, in these embodiments, when qualification system 406 determines that the item is subject to a minimum advertised price limitation, qualification system 406 also can determine that the item being made available for purchase by the user is ineligible, when the item is to be received by the user by user pick-up, to be made available for purchase at the user pick-up discounted retail price. As used herein, the term “minimized advertised price” can refer to a minimum retail price at which an entity making available an item for purchase by a user can make available the item for purchase by the user. For example, in many embodiments, the minimum advertised price can be designated by a third-party (e.g., a manufacturer of the item being made available for purchase by the user).

In some embodiments, qualification system 406 can reference (e.g., query) minimum advertised price database(s) 502 to evaluate whether the item is subject to a minimum advertised price limitation. Minimum advertised price database(s) 502 can store an index having a first set of fields identifying items being made available for purchase by the user, including the item being evaluated by qualification system 406, and a second set of fields corresponding to the first set of fields and identifying whether the items of the first set of fields are subject to minimum advertised price limitations. In these or other embodiments, minimum advertised price database(s) 502 can be updated from time to time, when applicable, to add or remove items and/or to modify whether the items are subject to minimum advertised prices.

In many embodiments, in order to evaluate whether the item being made available for purchase by the user is eligible, when the item is to be received by the user by user pick-up, to be made available for purchase at a user pick-up discounted retail price, qualification system 406 can evaluate whether the item is subject to store sharing. For example, in these embodiments, when qualification system 406 determines that the item is subject to store sharing, qualification system 406 also can determine that the item being made available for purchase by the user is ineligible, when the item is to be received by the user by user pick-up, to be made available for purchase at the user pick-up discounted retail price. In many embodiments, the item can be subject to store sharing when the entity making available the item for purchase by the user is making available the item for purchase by the user for or on behalf of a third-party (e.g., a third-party vendor).

In some embodiments, qualification system 406 can reference (e.g., query) store sharing database(s) 503 to evaluate whether the item is subject to store sharing. Store sharing database(s) 503 can store an index having a first set of fields identifying items being made available for purchase by the user, including the item being evaluated by qualification system 406, and a second set of fields corresponding to the first set of fields and identifying whether the items of the first set of fields are subject to store sharing. In these or other embodiments, store sharing database(s) 503 can be updated from time to time, when applicable, to add or remove items and/or to modify whether the items are subject to store sharing.

In many embodiments, when qualification system 406 determines that the item being made available for purchase by the user is ineligible, when the item is to be received by the user by user pick-up, to be made available for purchase at the user pick-up discounted retail price, qualification system 406 can notify engagement system 405 that the item being made available for purchase by the user is ineligible, when the item is to be received by the user by user pick-up, to be made available for purchase at the user pick-up discounted retail price. In these or other embodiments, when qualification system 406 determines that the item being made available for purchase by the user is ineligible to be received by the user by user pick-up, qualification system 406 can notify engagement system 405 that the item being made available for purchase by the user is ineligible to be received by the user by user pick-up.

Meanwhile, when engagement system 405 is notified by qualification system 406 that the item being made available for purchase by the user is ineligible, when the item is to be received by the user by user pick-up, to be made available for purchase at the user pick-up discounted retail price, engagement system 405 can prevent display of (i) the option for the user to receive by user pick-up the item being made available for purchase by the user, (ii) the user pick-up discounted retail price, and/or (iii) a difference of the home delivery retail price and the user pick-up discounted retail price from being communicated (e.g., displayed) to the user on a GUI. For example, in some of these embodiments, engagement system 405 can instruct user computer system 304 (FIG. 3) not to communicate (i) the option for the user to receive by user pick-up the item being made available for purchase by the user, (ii) the user pick-up discounted retail price, and/or (iii) the difference of the home delivery retail price and the user pick-up discounted retail price to the user. In further embodiments, engagement system 405 can prevent (i) the option for the user to receive by user pick-up the item being made available for purchase by the user, (ii) the user pick-up discounted retail price, and/or (iii) the difference of the home delivery retail price and the user pick-up discounted retail price from being displayed to the user at user computer system 304 (FIG. 3) on the GUI on which the item being made available for purchase is displayed. For example, GUIs described in FIGS. 11-13 could be modified to remove (i) the option for the user to receive by user pick-up the item being made available for purchase by the user, (ii) the user pick-up discounted retail price, and/or (iii) a difference of the home delivery retail price and the user pick-up discounted retail price.

In these or other embodiments, when engagement system 405 is notified by qualification system 406 that the item being made available for purchase by the user is ineligible to be received by the user by user pick-up, engagement system 405 can prevent the option for the user to receive by user pick-up the item being made available for purchase by the user from being communicated to the user on a GUI. For example, in some of these embodiments, engagement system 405 can instruct user computer system 304 (FIG. 3) not to communicate the option for the user to receive by user pick-up the item being made available for purchase by the user to the user. In further embodiments, engagement system 405 can prevent the option for the user to receive by user pick-up the item being made available for purchase by the user from being displayed to the user at user computer system 304 (FIG. 3) on the GUI on which the item being made available for purchase is displayed. For example, GUIs described in FIGS. 11-13 could be modified to remove the option for the user to receive by user pick-up the item being made available for purchase by the user.

In some embodiments, preventing (i) the option for the user to receive by user pick-up the item being made available for purchase by the user, (ii) the user pick-up discounted retail price, and/or (iii) the difference of the home delivery retail price and the user pick-up discounted retail price from being communicated to the user on a GUI advantageously can prevent the user from being incorrectly promised user pick-up of the item being made available for purchase by the user and/or the user pick-up discounted retail price when the user pick-up of the item being made available for purchase by the user and/or the user pick-up discounted retail price are not available. Accordingly, in some embodiments, by programmatically preventing the option for the user to receive by user pick-up the item being made available for purchase by the user and/or the user pick-up discounted retail price from being communicated (e.g., displayed) to the user, system 300 (FIG. 3) can mitigate or eliminate mispromising user pick-up of the item being made available for purchase by the user and/or the user pick-up discounted retail price when the user pick-up of the item being made available for purchase by the user and/or the user pick-up discounted retail price are not available, as a result of human error. Preventing (i) the option for the user to receive by user pick-up the item being made available for purchase by the user, (ii) the user pick-up discounted retail price, and/or (iii) the difference of the home delivery retail price and the user pick-up discounted retail price from being communicated to the user on a GUI can also further optimize the GUI for easy navigation by the user by removing clutter, thereby allowing the user to more efficiently navigate through the GUI. This effect can be further enhanced when a user is navigating on a small screen, such as on a mobile device, because very little screen space is available for a GUI, and removing unneeded items provides for easier navigation and more efficient use of screen space. Such an advantage can be unique to the realm of computers and GUIs in contrast to conventional human activities.

In many embodiments, when qualification system 406 determines that the item being made available for purchase by the user (i) is eligible to be received by the user by user pick-up, (ii) is not subject to a minimum advertised price, and/or (iii) is not subject to store sharing, qualification system 406 also can determine that the item being made available for purchase by the user is eligible, when the item is to be received by the user by user pick-up, to be made available for purchase at the user pick-up discounted retail price. When qualification system 406 determines that the item being made available for purchase by the user is eligible, when the item is to be received by the user by user pick-up, to be made available for purchase at the user pick-up discounted retail price, qualification system 406 can notify engagement system 405 that the item being made available for purchase by the user is eligible, when the item is to be received by the user by user pick-up, to be made available for purchase at the user pick-up discounted retail price. In these or other embodiments, when qualification system 406 determines that the item being made available for purchase by the user is eligible to be received by the user by user pick-up, qualification system 406 can notify engagement system 405 that the item being made available for purchase by the user is eligible to be received by the user by user pick-up.

Meanwhile, when engagement system 405 is notified by qualification system 406 that the item being made available for purchase by the user is eligible, when the item is to be received by the user by user pick-up, to be made available for purchase at the user pick-up discounted retail price, engagement system 405 can cause (i) the option for the user to receive by user pick-up the item being made available for purchase by the user, (ii) the user pick-up discounted retail price, and/or (iii) the difference of the home delivery retail price and the user pick-up discounted retail price to be communicated (e.g., displayed) to the user. For example, in some of these embodiments, engagement system 405 can instruct user computer system 304 (FIG. 3) to communicate (i) the option for the user to receive by user pick-up the item being made available for purchase by the user, (ii) the user pick-up discounted retail price, and/or (iii) the difference of the home delivery retail price and the user pick-up discounted retail price to the user. In further embodiments, engagement system 405 can cause (i) the option for the user to receive by user pick-up the item being made available for purchase by the user, (ii) the user pick-up discounted retail price, and/or (iii) the difference of the home delivery retail price and the user pick-up discounted retail price to be displayed to the user at user computer system 304 (FIG. 3) on the GUI on which the item being made available for purchase is displayed. In various embodiments, the GUI can comprise GUIs described in FIGS. 11-13.

In these or other embodiments, when engagement system 405 is notified by qualification system 406 that the item being made available for purchase by the user is eligible to be received by the user by user pick-up, engagement system 405 can cause the option for the user to receive by user pick-up the item being made available for purchase by the user to be communicated to the user. For example, in some of these embodiments, engagement system 405 can instruct user computer system 304 (FIG. 3) to communicate the option for the user to receive by user pick-up the item being made available for purchase by the user to the user. In further embodiments, engagement system 405 can cause the option for the user to receive by user pick-up the item being made available for purchase by the user to be displayed to the user at user computer system 304 (FIG. 3) on the GUI on which the item being made available for purchase is displayed. In various embodiments, the GUI can comprise GUIs described in FIGS. 11-13.

In many embodiments, engagement system 405 can cause (i) the option for the user to receive by user pick-up the item being made available for purchase by the user, (ii) the user pick-up discounted retail price, and/or (iii) the difference of the home delivery retail price and the user pick-up discounted retail price to be communicated (e.g., displayed) to the user before or after engagement system 405 receives from user computer system 304 (FIG. 3) (a) the selection of the item being made available for purchase by the user from the user, (b) the request from the user to purchase the item being made available for purchase by the user, and/or (c) the selection to receive the item being made available for purchase by the user by user pick-up or the selection to receive the item being made available for purchase by the user by home delivery. In many embodiments, (a) the selection of the item being made available for purchase by the user from the user, (b) the request from the user to purchase the item being made available for purchase by the user, and/or (c) the selection to receive the item being made available for purchase by the user by user pick-up or the selection to receive the item being made available for purchase by the user by home delivery can be entered into a GUI by the user. In various embodiments, the GUI can comprise GUIs described in FIGS. 11-13. Further, in these or other embodiments, engagement system 405 can cause (i) the option for the user to receive by user pick-up the item being made available for purchase by the user, (ii) the user pick-up discounted retail price, and/or (iii) the difference of the home delivery retail price and the user pick-up discounted retail price to be communicated (e.g., displayed) to the user at the same or at different times.

In many embodiments, when engagement system 405 is notified by qualification system 406 that the item being made available for purchase by the user is eligible, when the item is to be received by the user by user pick-up, to be made available for purchase at the user pick-up discounted retail price, engagement system 405 can cause (e.g., instruct) discount system 407 to determine the user pick-up discounted retail price for the item being made available for purchase by the user. In some embodiments, when engagement system 405 is notified by qualification system 406 that the item being made available for purchase by the user is eligible, when the item is to be received by the user by user pick-up, to be made available for purchase at the user pick-up discounted retail price, engagement system 405 can cause (e.g., instruct) discount system 407 to determine a difference of the home delivery retail price and the user pick-up discounted retail price for the item being made available for purchase by the user. Further, engagement system 405 can receive from discount system 407 the user pick-up discounted retail price for the item being made available for purchase by the user and/or the difference of the home delivery retail price and the user pick-up discounted retail price for the item being made available for purchase by the user.

Discount system 407 can determine the user pick-up discounted retail price for the item being made available for purchase by the user. In some embodiments, discount system 407 can determine a difference of the home delivery retail price and the user pick-up discounted retail price for the item being made available for purchase by the user.

In many embodiments, in order to determine the user pick-up discounted retail price for the item being made available for purchase by the user, discount system 407 can calculate a package shipping cost savings for the item being made available for purchase by the user. In some embodiments, the package shipping cost savings can refer to a difference in (i) a cost to ship by home delivery a package containing the item being made available for purchase by the user and (ii) a cost to ship by store delivery the package containing the item being made available for purchase by the user. Accordingly, in these or other embodiments, in order to calculate the package shipping cost savings for the item being made available for purchase by the user, discount system 407 can calculate (i) the cost to ship by home delivery the package containing the item, (ii) the cost to ship by store delivery the package containing the item, and (iii) the difference in the cost to ship by home delivery the package containing the item and the cost to ship by store delivery the package containing the item.

For example, in some embodiments, in order to calculate the cost to ship by home delivery the package containing the item being made available for purchase by the user, discount system 407 can calculate (i) a product of an associate home delivery percentage and an associate home delivery cost per package, (ii) a product of a parcel service home delivery percentage and a parcel service home delivery cost per package, and (iii) a sum of the item of the associate home delivery percentage and the associate home delivery cost per package and the item of the parcel service home delivery percentage and the parcel service home delivery cost per package.

In some embodiments, the associate home delivery percentage can refer to an estimated percentage likelihood that the item being made available for purchase by the user, when received by home delivery, would be delivered by associate home delivery, and the parcel service home delivery percentage can refer to an estimated percentage likelihood that the item being made available for purchase by the user, when received by home delivery, would be delivered by parcel service home delivery. In these embodiments, the parcel service home delivery percentage can be a difference of one hundred percent less the associate home delivery percentage, and vice versa. In some embodiments, the associate home delivery percentage and parcel service home delivery percentage can be estimated for contemporary values. In other embodiments, the associate home delivery percentage and parcel service home delivery percentage can be estimated for future values.

Meanwhile, in these or other embodiments, the associate home delivery cost per package can refer to an estimated cost to deliver by associate home delivery a package containing the item being made available for purchase by the user and, in some embodiments, can be a function of the weight and/or dimensions of the package. In some embodiments, discount system 407 can reference (e.g., query) associate home delivery cost per package database(s) 504 to determine (e.g., retrieve) the associate home delivery cost per package for the item being made available for purchase by the user. Associate home delivery cost per package database(s) 504 can store an index having a set of fields identifying estimated costs to deliver by associate home delivery a package containing the item being made available for purchase by the user for different weights and/or dimensions of the package. In these or other embodiments, associate home delivery cost per package database(s) 504 can be updated from time to time, when applicable. In many embodiments, the associate home delivery cost per package that discount system 407 determines (e.g., retrieves) from associate home delivery cost per package database(s) 504 can be an estimated cost to deliver by associate home delivery a package containing the item being made available for purchase by the user and having similar or identical weight and/or dimensions to the item being made available for purchase by the user. In further embodiments, discount system 407 can reference (e.g., query) item database(s) 510 to determine (e.g., retrieve) the weight and/or dimensions of the item being made available for purchase by the user. Item database(s) 510 can store an index having a set of fields identifying weights and/or dimensions of one or more (e.g., all) items made available for purchase by users by the entity making available the item for purchase by the user, including a weight and/or dimensions of the item being made available for purchase by the user. In these or other embodiments, item database(s) 510 can be updated from time to time, when applicable.

Further, in these or other embodiments, the parcel service home delivery cost per package can refer to an estimated cost to deliver by parcel service home delivery a package containing the item being made available for purchase by the user and, in some embodiments, can be a function of the weight and/or dimensions of the package. In some embodiments, discount system 407 can reference (e.g., query) parcel service home delivery cost per package database(s) 505 to determine (e.g., retrieve) the parcel service home delivery cost per package for the item being made available for purchase by the user. Parcel service home delivery cost per package database(s) 505 can store an index having a set of fields identifying estimated costs to deliver by parcel service home delivery a package containing the item being made available for purchase by the user for different weights and/or dimensions of the package. In these or other embodiments, parcel service home delivery cost per package database(s) 505 can be updated from time to time, when applicable. In many embodiments, the parcel service home delivery cost per package that discount system 407 determines (e.g., retrieves) from parcel service home delivery cost per package database(s) 505 can be an estimated cost to deliver by parcel service home delivery a package containing the item being made available for purchase by the user and having similar or identical weight and/or dimensions to the item being made available for purchase by the user. In further embodiments, discount system 407 can reference (e.g., query) item database(s) 510 to determine (e.g., retrieve) the weight and/or dimensions of the item being made available for purchase by the user.

In some embodiments, in order to calculate the cost to ship by store delivery the package containing the item being made available for purchase by the user, discount system 407 can calculate (i) a of a line-haul store delivery percentage and a line-haul store delivery cost per package, (ii) a product of a parcel service store delivery percentage and a parcel service store delivery cost per package, and (iii) a sum of the item of the line-haul store delivery percentage and the line-haul store delivery cost per package and the item of the parcel service store delivery percentage and the parcel service store delivery cost per package.

In some embodiments, the line-haul store delivery percentage can refer to an estimated percentage likelihood that the item being made available for purchase by the user, when received by store delivery, would be delivered by line-haul store delivery, and the parcel service store delivery percentage can refer to an estimated percentage likelihood that the item being made available for purchase by the user, when received by store delivery, would be delivered by parcel service store delivery. In these embodiments, the parcel service store delivery percentage can be a difference of one hundred percent less the line-haul store delivery percentage, and vice versa.

Meanwhile, in these or other embodiments, the line-haul store delivery cost per package can refer to an estimated cost to deliver by line-haul store delivery a package containing the item being made available for purchase by the user and, in some embodiments, can be a function of the weight and/or dimensions of the package. In some embodiments, discount system 407 can reference (e.g., query) line-haul store delivery cost per package database(s) 506 to determine (e.g., retrieve) the line-haul store delivery cost per package for the item being made available for purchase by the user. Line-haul store delivery cost per package database(s) 506 can store an index having a set of fields identifying estimated costs to deliver by line-haul store delivery a package containing the item being made available for purchase by the user for different weights and/or dimensions of the package. In these or other embodiments, line-haul store delivery cost per package database(s) 506 can be updated from time to time, when applicable. In many embodiments, the line-haul store delivery cost per package that discount system 407 determines (e.g., retrieves) from line-haul store delivery cost per package database(s) 506 can be an estimated cost to deliver by line-haul store delivery a package containing the item being made available for purchase by the user and having similar or identical weight and/or dimensions to the item being made available for purchase by the user. In further embodiments, discount system 407 can reference (e.g., query) item database(s) 510 to determine (e.g., retrieve) the weight and/or dimensions of the item being made available for purchase by the user.

Further, in these or other embodiments, the parcel service store delivery cost per package can refer to an estimated cost to deliver by parcel service store delivery a package containing the item being made available for purchase by the user, and in some embodiments, can be a function of the weight and/or dimensions of the package. In some embodiments, discount system 407 can reference (e.g., query) parcel service store delivery cost per package database(s) 507 to determine (e.g., retrieve) the parcel service store delivery cost per package for the item being made available for purchase by the user. Parcel service store delivery cost per package database(s) 507 can store an index having a set of fields identifying estimated costs to deliver by parcel service store delivery a package containing the item being made available for purchase by the user for different weights and/or dimensions of the package. In these or other embodiments, parcel service store delivery cost per package database(s) 507 can be updated from time to time, when applicable. In many embodiments, the parcel service store delivery cost per package that discount system 407 determines (e.g., retrieves) from parcel service store delivery cost per package database(s) 507 can be an estimated cost to deliver by parcel service store delivery a package containing the item being made available for purchase by the user and having similar or identical weight and/or dimensions to the item being made available for purchase by the user. In further embodiments, discount system 407 can reference (e.g., query) item database(s) 510 to determine (e.g., retrieve) the weight and/or dimensions of the item being made available for purchase by the user.

In some embodiments, the associate home delivery cost per package, the parcel service home delivery cost per package, the line-haul store delivery cost per package, and the parcel service store delivery cost per package can be estimated for contemporary values. In other embodiments, the associate home delivery cost per package, the parcel service home delivery cost per package, the line-haul store delivery cost per package, and the parcel service store delivery cost per package can be estimated for future values.

Further, in many embodiments, in order to determine the user pick-up discounted retail price for the item being made available for purchase by the user, discount system 407 can calculate a unit shipping cost savings. In some embodiments, the unit shipping cost savings can refer to a quotient of the package shipping cost savings and a units per package value associated with the item. Accordingly, in these or other embodiments, in order to calculate the unit cost savings for the item being made available for purchase by the user, discount system 407 can calculate the quotient of the package shipping cost savings and the units per package value associated with the item. In various embodiments, in order to determine the user pick-up discounted retail price for the item being made available for purchase by the user, discount system 407 can calculate a unit shipping cost savings based upon density of population surrounding a store, distance reduction over delivering to a home, and/or and other efficiencies achieved by delivering to a store instead of a user's house. For example, many items can be housed exclusively in store and not at a warehouse, thereby making in store pick-up more efficient and less costly. As another example, when multiple in store pick-up orders originate from different users at a same origin, items for both orders can be shipped to a store in a same package, as opposed to multiple packages, thereby making in store pick-up more efficient and less costly.

In some embodiments, the units per package value can refer to an estimated quantity of units able to be shipped in the package containing the item being made available for purchase by the user when the item is delivered. In some embodiments, discount system 407 can reference (e.g., query) units per package value database(s) 508 to determine (e.g., retrieve) the units per package value for the item being made available for purchase by the user. Units per package value database(s) 508 can store an index having a first set of fields identifying items being made available for purchase by the user, including the item for which discount system 407 is determining the user pick-up discounted retail price, a second set of fields corresponding to the first set of fields and identifying whether the items of the first set of fields are sortable or non-sortable, and a third set of fields corresponding to the first set of fields and the second set of fields and identifying units per package values for the items. In these or other embodiments, units per package value database(s) 508 can be updated from time to time, when applicable.

In these or other embodiments, when the items are non-sortable, the units per package value can be 1. In some embodiments, frozen items, fragile items, and/or bulk items can be non-sortable. Meanwhile, when the items are sortable, the units per package value can be quotients of one divided by average quantities of units per package in one or more retail tiers associated with the items. For example, the retail tier(s) can comprise any suitable classification or classifications by which the items can be grouped (e.g., perishable items, luxury items, household items, etc.). In many embodiments, implementing discount system 407 such that a units per package value is determined as a function of an average quantity of units per package in a retail tier of the item rather than for the individual item can permit central computer system 301 (FIG. 3) to operate more efficiently by reducing a quantity of data needing to be stored at units per package value database(s) 508 and by permitting data to be retrieved from units per package value database(s) 508 more quickly.

Further, in many embodiments, in order to determine the user pick-up discounted retail price for the item being made available for purchase by the user, discount system 407 can calculate a user pick-up discount. In some embodiments, the user pick-up discount can refer to a product of the unit shipping cost savings and a predetermined discount percentage. Accordingly, in these or other embodiments, in order to calculate the user pick-up discount for the item being made available for purchase by the user, discount system 407 can calculate the item of the unit shipping cost savings and the predetermined discount percentage. The predetermined discount percentage can comprise any suitable percentage value. Further, the predetermined discount percentage can be designated by the entity making available the item for purchase by the user.

Further, in many embodiments, in order to determine the user pick-up discounted retail price for the item being made available for purchase by the user, discount system 407 can assign the user pick-up discounted retail price as a difference of the home delivery retail price and the user pick-up discount. In other embodiments, in order to determine the user pick-up discounted retail price for the item being made available for purchase by the user, discount system 407 can assign the user pick-up discounted retail price as a difference of the home delivery retail price and a lowest value of (i) the user pick-up discount and/or (ii) a first limited user pick-up discount and/or a second limited user pick-up discount. Accordingly, discount system 407 can calculate a difference of the home delivery retail price and the user pick-up discount, and when applicable, a difference of the home delivery retail price and the first limited user pick-up discount and/or a difference of the home delivery retail price and the second limited user pick-up discount.

In some embodiments, discount system 407 can reference (e.g., query) home delivery retail price database(s) 509 to determine (e.g., retrieve) the home delivery retail price for the item being made available for purchase by the user. Home delivery retail price database(s) 509 can store an index having a first set of fields identifying items being made available for purchase by the user, including the item for which discount system 407 is determining the user pick-up discounted retail price, and a second set of fields corresponding to the first set of fields and identifying the home delivery retail prices associated with the items. In these or other embodiments, home delivery retail price database(s) 509 can be updated from time to time, when applicable.

In these or other embodiments, the first limited user pick-up discount can refer to a product of the home delivery retail price and a predetermined maximum retail percentage. For example, the predetermined maximum retail percentage can comprise any suitable percentage value. Further, the predetermined maximum retail percentage can be designated by the entity making available the item for purchase by the user. Accordingly, in some embodiments, discount system 407 can calculate the item of the home delivery retail price and the predetermined maximum retail percentage, and can assign the item of the home delivery retail price and the predetermined maximum retail percentage as the first limited user pick-up discount.

In these or other embodiments, the second limited user pick-up discount can refer to a predetermined maximum discount. For example, the predetermined maximum discount can comprise any suitable monetary value. Further, the predetermined maximum discount can be designated (e.g., assigned) by the entity making available the item for purchase by the user. In various embodiments, a max discount cannot exceed a price of an item.

As indicated above, implementing system 300 (FIG. 3) can permit part or all of a cost savings of the item being made available for purchase by the user that result by the item, when purchased, being received by the user by user pick-up rather than home delivery to be passed on to the user. In some embodiments, the user pick-up discounted retail price for the item being made available for purchase by the user can be limited so that less than all of the cost savings are passed on to the user. As a result, the entity making available the item for purchase by the user also can benefit from system 300 (FIG. 3). For example, in these or other embodiments, the user pick-up discounted retail price for the item being made available for purchase by the user can be limited according to the predetermined discount percentage, the predetermined maximum retail percentage, and/or the predetermined maximum discount implemented, as described above.

GUI system 408 can store elements of and construct displays of various GUIs capable of encouraging user pick-up over home delivery. In some embodiments, GUI system 408 can store and create GUIs comprising text and/or graphics (images). In the same or different embodiments, GUI system 408 can store and create GUIs comprising a heads up display (“HUD”). When a GUI stored and constructed by GUI system 408 comprises a HUD, the GUI can be projected onto glass, plastic, displayed in midair as a hologram, or displayed on monitor 106 (FIG. 1). In various embodiments, GUIs stored and created by GUI system 408 can be color or black and white. In many embodiments, GUIs stored and created by GUI system 408 can comprise an application running on a computer system, such as computer system 100, user computer systems 303, and/or central computer system 301. In the same or different embodiments, GUIs stored and created by GUI system 408 can comprise a website accessed through internet 320. In the same or different embodiments, GUIs stored and created by GUI system 408 can be displayed as or on a virtual reality (VR) and/or augmented reality (AR) system or display. In many embodiments, GUIs stored and created by GUI system 408 can comprise GUIs described in FIGS. 11-14 below.

For simplicity and clarity of explanation, the functionality of engagement system 405, qualification system 406, discount system 407, and/or GUI system 408 generally is described herein as it relates particularly to user computer system 304 of user computer system(s) 303 and a single item, but in many embodiments, the functionality of personalization system 406 can be extended to multiple items and multiple of user computer system(s) 303, at the same or at different times.

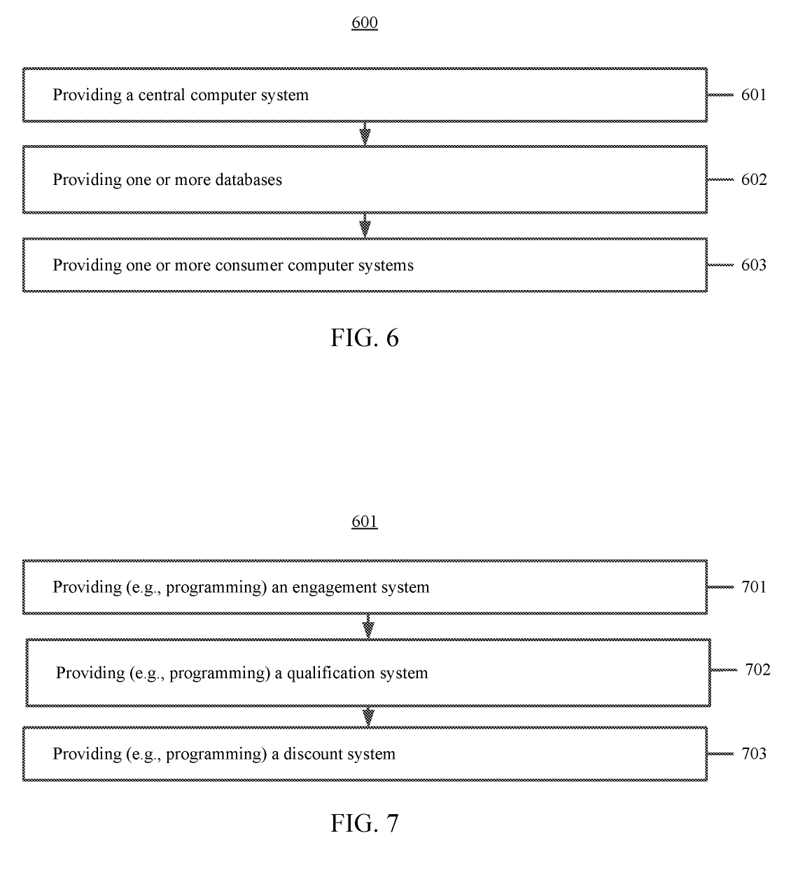

Turning ahead now in the drawings, FIG. 6 illustrates a flow chart for an embodiment of a method 600 of providing (e.g., manufacturing) a system. Method 600 is merely exemplary and is not limited to the embodiments presented herein. Method 600 can be employed in many different embodiments or examples not specifically depicted or described herein. In some embodiments, the activities of method 600 can be performed in the order presented. In other embodiments, the activities of the method 600 can be performed in any other suitable order. In still other embodiments, one or more of the activities in method 600 can be combined or skipped. In many embodiments, the system can be similar or identical to system 300 (FIG. 3).

In many embodiments, method 600 can comprise activity 601 of providing a central computer system. In some embodiments, the central computer system can be similar or identical to central computer system 301 (FIG. 3). FIG. 7 illustrates an exemplary activity 601, according to the embodiment of FIG. 6.

For example, in many embodiments, activity 601 can comprise activity 701 of providing (e.g., programming) an engagement system. In some embodiments, the engagement system can be similar or identical to engagement system 405 (FIG. 4).

In many embodiments, activity 601 can comprise activity 702 of providing (e.g., programming) a qualification system. In some embodiments, the qualification system can be similar or identical to qualification system 406 (FIG. 4).

In many embodiments, activity 601 can comprise activity 703 of providing (e.g., programming) a discount system. In some embodiments, the discount system can be similar or identical to discount system 407 (FIG. 4).

Referring now back to FIG. 6, in some embodiments, method 600 can comprise activity 602 of providing one or more databases. For example, in some embodiments, one or more of the database(s) can be similar or identical to one or more of database(s) 302 (FIG. 3). In other embodiments, activity 602 can be omitted.

Further, in some embodiments, method 600 can comprise activity 603 of providing one or more user computer systems. The user computer system(s) can be similar or identical to user computer system(s) 303 (FIG. 3). In other embodiments, activity 603 can be omitted.

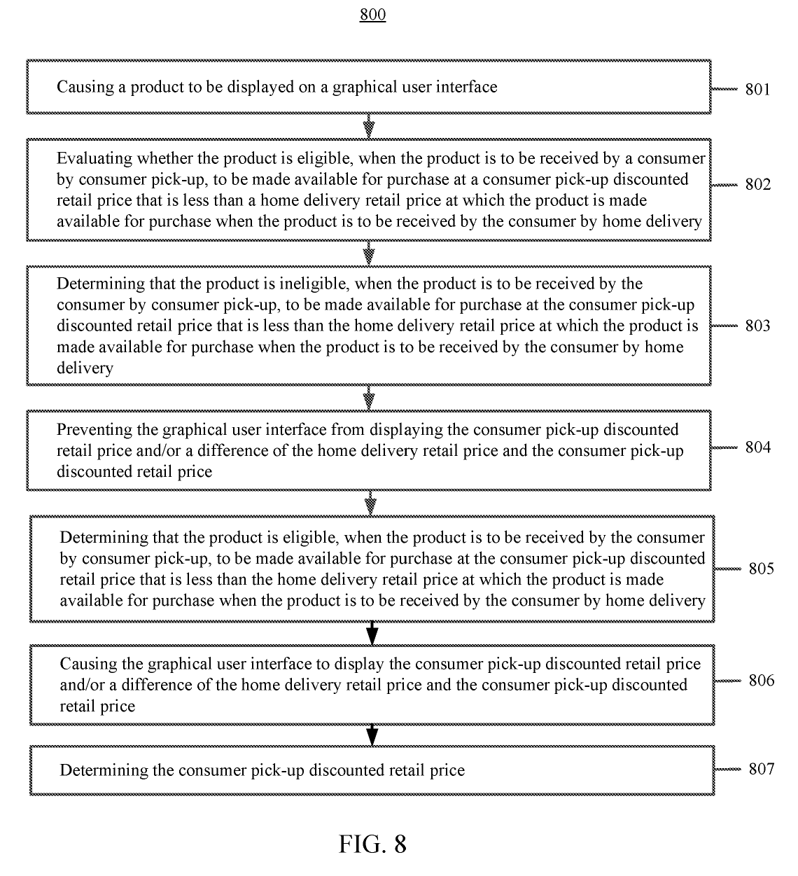

Turning ahead now in the drawings, FIG. 8 illustrates a flow chart for an embodiment of a method 800. For example, in many embodiments, method 800 can be implemented to encourage user pick-up over home delivery of an item being made available to a user for purchase.

Method 800 is merely exemplary and is not limited to the embodiments presented herein. Method 800 can be employed in many different embodiments or examples not specifically depicted or described herein. In some embodiments, the activities of method 800 can be performed in the order presented. In other embodiments, the activities of the method 800 can be performed in any other suitable order. In still other embodiments, one or more of the activities in method 800 can be combined or skipped.

In many embodiments, method 800 can comprise activity 801 of causing an item to be displayed on a GUI. In various embodiments, the GUI can comprise GUIs described in FIGS. 11-13. In some embodiments, performing activity 801 can be similar or identical to causing an item to be displayed on a GUI as described above with respect to system 300 (FIG. 3). Further, the item can be similar or identical to the item described above with respect to system 300 (FIG. 3); and/or the GUI can be similar or identical to the GUI described above with respect to system 300 (FIG. 3).

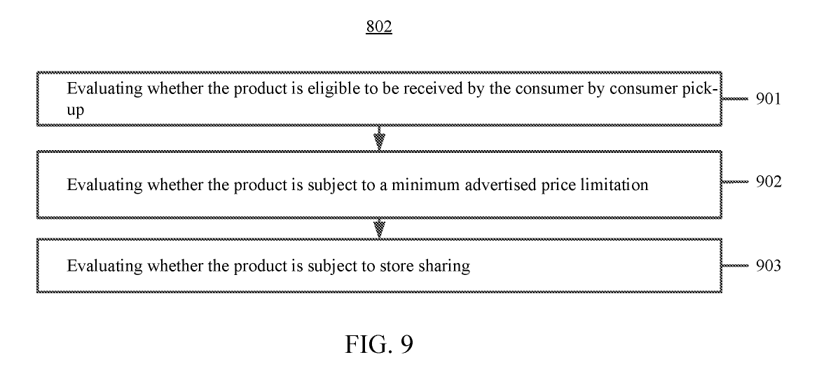

In many embodiments, method 800 can comprise activity 802 of evaluating whether the item is eligible, when the item is to be received by a user by user pick-up, to be made available for purchase at a user pick-up discounted retail price that is less than a home delivery retail price at which the item is made available for purchase when the item is to be received by the user by home delivery. In some embodiments, performing activity 802 can be similar or identical to evaluating whether the item is eligible, when the item is to be received by a user by user pick-up, to be made available for purchase at a user pick-up discounted retail price that is less than a home delivery retail price at which the item is made available for purchase when the item is to be received by the user by home delivery as described above with respect to system 300 (FIG. 3). Further, the user can be similar or identical to the user described above with respect to system 300 (FIG. 3); the user pick-up discounted retail price can be similar or identical to the user pick-up discounted retail price described above with respect to system 300 (FIG. 3); and/or the home delivery retail price can be similar or identical to the home delivery retail price described above with respect to system 300 (FIG. 3). FIG. 9 illustrates an exemplary activity 802, according to the embodiment of FIG. 8.

For example, in many embodiments, activity 802 can comprise activity 901 of evaluating whether the item is eligible to be received by the user by user pick-up. In some embodiments, performing activity 901 can be similar or identical to evaluating whether the item is eligible to be received by the user by user pick-up as described above with respect to system 300 (FIG. 3).

In many embodiments, activity 802 can comprise activity 902 of evaluating whether the item is subject to a minimum advertised price limitation. In some embodiments, performing activity 902 can be similar or identical to evaluating whether the item is subject to a minimum advertised price limitation as described above with respect to system 300 (FIG. 3). In other embodiments, activity 902 can be omitted.

In many embodiments, activity 802 can comprise activity 903 of evaluating whether the item is subject to store sharing. In some embodiments, performing activity 903 can be similar or identical to evaluating whether the item is subject to store sharing as described above with respect to system 300 (FIG. 3). In other embodiments, activity 903 can be omitted.

Referring now back to FIG. 8, in many embodiments, method 800 can comprise activity 803 of determining that the item is ineligible, when the item is to be received by the user by user pick-up, to be made available for purchase at the user pick-up discounted retail price that is less than the home delivery retail price at which the item is made available for purchase when the item is to be received by the user by home delivery. In some embodiments, performing activity 803 can be similar or identical to determining that the item is ineligible, when the item is to be received by the user by user pick-up, to be made available for purchase at the user pick-up discounted retail price that is less than the home delivery retail price at which the item is made available for purchase when the item is to be received by the user by home delivery as described above with respect to system 300 (FIG. 3).

Further, in many embodiments, method 800 can comprise activity 804 of preventing the GUI from displaying the user pick-up discounted retail price and/or a difference of the home delivery retail price and the user pick-up discounted retail price. In various embodiments, the GUI can comprise GUIs described in FIGS. 11-13. In some embodiments, performing activity 804 can be similar or identical to preventing the GUI from displaying the user pick-up discounted retail price and/or a difference of the home delivery retail price and the user pick-up discounted retail price as described above with respect to system 300 (FIG. 3). For example, in some embodiments, activity 804 can be performed when activity 803 is performed.

In many embodiments, method 800 can comprise activity 805 of determining that the item is eligible, when the item is to be received by the user by user pick-up, to be made available for purchase at the user pick-up discounted retail price that is less than the home delivery retail price at which the item is made available for purchase when the item is to be received by the user by home delivery. In some embodiments, performing activity 805 can be similar or identical to determining that the item is eligible, when the item is to be received by the user by user pick-up, to be made available for purchase at the user pick-up discounted retail price that is less than the home delivery retail price at which the item is made available for purchase when the item is to be received by the user by home delivery as described above with respect to system 300 (FIG. 3).

Further, in many embodiments, method 800 can comprise activity 806 of causing the GUI to display the user pick-up discounted retail price and/or a difference of the home delivery retail price and the user pick-up discounted retail price. In various embodiments, the GUI can comprise GUIs described in FIGS. 11-13. In some embodiments, performing activity 806 can be similar or identical to causing the GUI to display the user pick-up discounted retail price and/or a difference of the home delivery retail price and the user pick-up discounted retail price as described above with respect to system 300 (FIG. 3). For example, in some embodiments, activity 806 can be performed when activity 805 is performed. In these or other embodiments, activities 803 and 804 can be omitted when activity 805 is performed, and activities 805 and 806 can be omitted when activity 803 is performed.

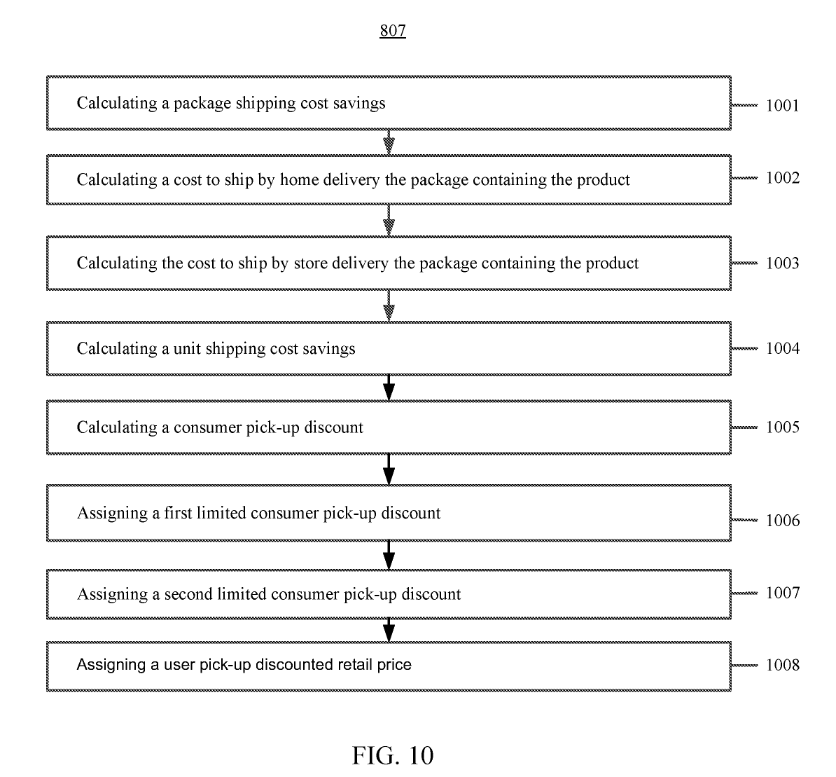

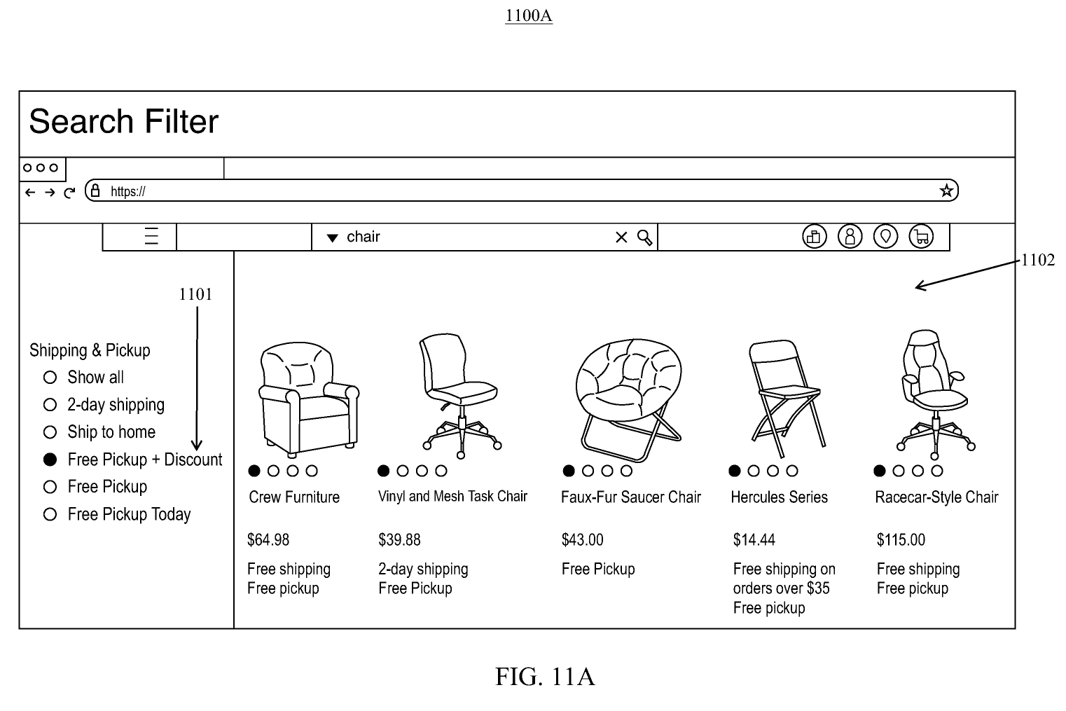

In many embodiments, method 800 can comprise activity 807 of determining the user pick-up discounted retail price. In some embodiments, performing activity 807 can be similar or identical to determining the user pick-up discounted retail price as described above with respect to system 300 (FIG. 3). In some embodiments, activity 807 can be omitted when activities 803 and 804 are performed. FIG. 10 illustrates an exemplary activity 807, according to the embodiment of FIG. 8.

For example, in many embodiments, activity 807 can comprise activity 1001 of calculating a package shipping cost savings. In some embodiments, performing activity 1001 can be similar or identical to calculating a package shipping cost savings as described above with respect to system 300 (FIG. 3). Further, the package shipping cost savings can be similar or identical to the package shipping cost savings described above with respect to system 300 (FIG. 3).

In many embodiments, activity 807 can comprise activity 1002 of calculating a cost to ship by home delivery the package containing the item. In some embodiments, performing activity 1002 can be similar or identical to calculating a cost to ship by home delivery the package containing the item as described above with respect to system 300 (FIG. 3).

In many embodiments, activity 807 can comprise activity 1003 of calculating the cost to ship by store delivery the package containing the item. In some embodiments, performing activity 1003 can be similar or identical to calculating the cost to ship by store delivery the package containing the item as described above with respect to system 300 (FIG. 3).

In many embodiments, activity 807 can comprise activity 1004 of calculating a unit shipping cost savings. In some embodiments, performing activity 1004 can be similar or identical to calculating a unit shipping cost savings as described above with respect to system 300 (FIG. 3). Further, the unit shipping cost savings can be similar or identical to the unit shipping cost savings described above with respect to system 300 (FIG. 3).

In many embodiments, activity 807 can comprise activity 1005 of calculating a user pick-up discount. In some embodiments, performing activity 1005 can be similar or identical to calculating a user pick-up discount as described above with respect to system 300 (FIG. 3). Further, the user pick-up discount can be similar or identical to the user pick-up discounted described above with respect to system 300 (FIG. 3).

In many embodiments, activity 807 can comprise activity 1006 of assigning a first limited user pick-up discount. In some embodiments, performing activity 1006 can be similar or identical to assigning a first limited user pick-up discount as described above with respect to system 300 (FIG. 3). Further, the first limited user pick-up discount can be similar or identical to the first limited user pick-up discount as described above with respect to system 300 (FIG. 3).

In many embodiments, activity 807 can comprise activity 1007 of assigning a second limited user pick-up discount. In some embodiments, performing activity 1006 can be similar or identical to assigning a second limited user pick-up discount as described above with respect to system 300 (FIG. 3). Further, the second limited user pick-up discount can be similar or identical to the second limited user pick-up discount as described above with respect to system 300 (FIG. 3).

In many embodiments, activity 807 can comprise activity 1008 of assigning the user pick-up discounted retail price as a difference of the home delivery retail price and a lowest value of the user pick-up discount, the first limited user pick-up discount, and the second limited user pick-up discount. In some embodiments, performing activity 1008 can be similar or identical to assigning the user pick-up discounted retail price as a difference of the home delivery retail price and a lowest value of the user pick-up discount, the first limited user pick-up discount, and the second limited user pick-up discount as described above with respect to system 300 (FIG. 3).

Referring back to FIG. 8, in many embodiments, method 800 can comprise an activity of facilitating providing to the user by user pick-up or by home delivery the item being made available for purchase by the user. In some embodiments, performing facilitating providing to the user by user pick-up or by home delivery the item being made available for purchase by the user can be similar or identical to facilitating providing to the user by user pick-up or by home delivery the item being made available for purchase by the user as described above with respect to system 300 (FIG. 3).

In some embodiments, one or more activities in method 800 can comprise an activity of using a distributed network comprising a distributed memory architecture to perform the associated activity of method 800. The distributed memory architecture can reduce the impact on the distributed network and system resources to reduce congestion in bottlenecks while still allowing data to be accessible from a central location.

Turning now to FIGS. 11A-J, various embodiments of GUIs configured to encourage user pick-up over home delivery of an item are shown. GUIs described in FIGS. 11A-J can be stored at memory storage device(s) 402 and/or non-transitory memory storage device(s) 403 and can be called and run at processor(s) 401, such as, for example, when the part or all of communication system 404, engagement system 405, qualification system 406, and discount system 407 cause a display to a user. As an example, a location for the user pick-up can be at a brick-and-mortar retail location of the retail store, at a brick-and-mortar warehouse location of the retail store, at a brick-and-mortar distribution center location of the retail store, at a third-party location on behalf of the retail store, or at a location that is less expensive for the retailer to deliver to than an individual home delivery.

Referring to FIG. 11A, an embodiment of an internet GUI 1100A is displayed. As an example, internet GUI 1100A can be for a display of a desktop computer. In many embodiments, GUI 1100A can comprise selectable element 1101 and search results 1102. In various embodiments, selectable element 1101 can be configured to apply a filter to search results 1102. In these embodiments, when selectable element 1101 is selected, individual search results of search results 1102 are removed from search results 1102 when the individual search results do not meet requirements of a filter applied by selectable element 1101. In more specific embodiments, a filter applied when selectable element 1101 is selected can comprise displaying only items that are determined by qualification system 406 (FIG. 4) to be eligible to be received by a user by user pick-up.

Referring to FIG. 11B, an embodiment of an internet GUI 1100B is displayed. In many embodiments, GUI 1100B can comprise item image 1103, item description 1104, item notification 1105, and/or add to cart button 1106. In some embodiments, item description 1104 can comprise a textual description of an item for sale on an eCommerce website. In the same or different embodiments, item description 1104 can comprise an item title. In various embodiments, item notification 1105 can be shown when an item shown in item image 1103 and/or described in item description 1104 is determined by qualification system 406 (FIG. 4) to be eligible to be received by a user by user pick-up. In the same or different embodiments, add to cart button 1106 can comprise a selectable element on GUI 1100B that, when selected, advances GUI 1100B to a different configuration.

Referring to FIG. 11C, an embodiment of an internet GUI 1100C is displayed. In many embodiments, GUI 1100C can comprise item image 1103, item description 1104, first cost with shipping indicator 1107, first cost with user pick-up indicator 1108, user pick-up availability indicator 1109, and/or checkout button 1112. In some embodiments, GUI 1100C can be generated after a user selects add to cart button 1106 (FIG. 11B). In various embodiments, first cost with user pick-up indicator 1108 and/or first user pick-up availability indicator 1109 can be shown when an item shown in item image 1103 and/or described in item description 1104 is determined by qualification system 406 (FIG. 4) to be eligible to be received by a user by user pick-up. In the same or different embodiments, first cost with shipping indicator 1107 can display a home delivery retail price as described above plus a local tax amount. In various embodiments, first cost with user pickup indicator 1108 can display a user pick-up discounted retail price as described above and/or a difference of the home delivery retail price and the user pick-up discounted retail price as described above plus a local tax amount. In many embodiments, user pick-up availability indicator 1109 can comprise text or images configured to inform a user that an item is eligible for reception by user pick-up. In this way, users can be informed that an item is eligible for reception by user pick-up, and therefore, the users can be more likely to select this option upon checkout. In the same or different embodiments, checkout button 1112 can comprise a selectable element on GUI 1100C that, when selected, advances GUI 1100C to a different configuration.

Referring to FIG. 11D, an embodiment of internet GUI 1100D is displayed. In many embodiments, GUI 1100D can comprise item image 1103, item description 1104, first cost with shipping indicator 1107, first cost with user pick-up indicator 1108, user pick-up availability indicator 1109, second cost with shipping indicator 1110, second cost with user pick-up indicator 1111, and/or checkout button 1112 (FIG. 11C). In various embodiments, first cost with user pick-up indicator 1108, user pick-up availability indicator 1109, and/or second cost with user pick-up indicator 1111 can be shown when an item shown in item image 1103 and/or described in item description 1104 is determined by qualification system 406 (FIG. 4) to be eligible to be received by a user by user pick-up. In the same or different embodiments, second cost with shipping indicator 1110 can display a home delivery retail price as described above. In various embodiments, second cost with user pickup indicator 1111 can display a user pick-up discounted retail price as described above and/or a difference of the home delivery retail price and the user pick-up discounted retail price as described above. In the same or different embodiments, checkout button 1112 can comprise a selectable element on GUI 1100D that, when selected, advances GUI 1100D to a different configuration.

Referring to FIG. 11E, an embodiment of an internet GUI 1100E is displayed. In many embodiments, GUI 1100E can comprise item image 1103, first cost with shipping indicator 1107, second cost with shipping indicator 1110, shipping selector 1113, pick-up selector 1114, and/or continue button 1115. In various embodiments, pick-up selector 1114 can be shown when an item shown in item image 1103 and/or described in item description 1104 is determined by qualification system 406 (FIG. 4) to be eligible to be received by a user by user pick-up. In various embodiments, shipping selector 1113, pick-up selector 1114, and/or continue button 1115 can comprise selectable user interface elements. In some embodiments, when shipping selector 1113 is selected by a user, amounts shown on first cost with shipping indicator 1107 and/or second cost with shipping indicator 1110 can be calculated, as described above, and displayed on GUI 1100E. In the same or different embodiments, when continue button 1115 is selected by a user, GUI 1100E is advanced to a different configuration.

Referring to FIG. 11F, an embodiment of an internet GUI 1100F is displayed. In many embodiments, GUI 1100F can comprise item image 1103, first cost with user pick-up indicator 1108, second cost with shipping indicator 1110, shipping selector 1113, pick-up selector 1114, continue button 1115, and/or pickup savings display 1116. In various embodiments, item notification 1105 (FIG. 11B) can be shown when an item shown in item image 1103 and/or described in item description 1104 (FIG. 11B) is determined by qualification system 406 (FIG. 4) to be eligible to be received by a user by user pick-up. In various embodiments, pickup savings display 1116 can comprise a unit shipping cost savings as described above. In some embodiments, when pick-up selector 1114 is selected by a user, amounts shown on first cost with user pick-up indicator 1108, second cost with shipping indicator 1110, and/or pickup savings display 1116, can be calculated, as described above, and displayed on GUI 1100F.

Referring to FIG. 11G, an embodiment of an internet GUI 1100G is displayed. In many embodiments, GUI 1100G can comprise item image 1103, first cost with user pick-up indicator 1108, second cost with shipping indicator 1110, pickup savings display 1116, and pickup discount indication 1117. In various embodiments, pickup savings display 1116 and/or pickup discount indication 1117 can be displayed on GUI 1100G when pick-up selector 1114 (FIG. 11F) has been selected in an earlier configuration of GUI 1100G, such as GUI 1100D (FIG. 11D) and/or GUI 1100F (FIG. 11F). In this way, users can be informed that they have selected reception by user pick-up and saved a certain amount of money by doing such, therefore users may be more likely to select this option in future transactions.

Referring to FIG. 11H, an embodiment of an internet GUI 1100H is displayed. In many embodiments, GUI 1100H can comprise an electronic message. In the same or different embodiments, the electronic message can comprise a text message, email, direct message, transcribed voice message, etc. In various embodiments, GUI 1100H can comprise item description 1104, item notification 1105, first cost with user pick-up indicator 1108, second cost with shipping indicator 1110, second cost with user pickup indicator 1111, and/or pickup savings display 1116. In various embodiments, GUI 1100H can be shown when an item described in item description 1104 is determined by qualification system 406 (FIG. 4) to be eligible to be received by a user by user pick-up and is purchased by a user.

Turning now to FIGS. 12A-E, various embodiments of internet GUIs configured to encourage user pick-up over home delivery of an item are shown. As an example, these internet GUIs can be mobile internet GUIs or internet GUIs configured to be shown on a display of a mobile device that is smaller than a display of a desktop computer. GUIs described in FIGS. 12A-J can be stored at memory storage device(s) 402 and/or non-transitory memory storage device(s) 403 and can be called and run at processor(s) 401, such as, for example, when the part or all of communication system 404, engagement system 405, qualification system 406, and discount system 407 cause a display to a user.

Referring to FIG. 12A, an embodiment of a mobile internet GUI 1200A is displayed. In many embodiments, GUI 1200A can comprise selectable element 1201 and done button 1202. In various embodiments, selectable element 1201 can be configured to apply a filter to a set of search results (not shown). In these embodiments, when selectable element 1201 is selected, individual search results of the set of search results (not shown) are removed from search results (not shown) when the individual search results do not meet requirements of a filter applied by selectable element 1201. In more specific embodiments, a filter applied when selectable element 1201 is selected can comprise displaying only items that are determined by qualification system 406 (FIG. 4) to be eligible to be received by a user by user pick-up. In the same or different embodiments, done button 1202 can comprise a selectable element on GUI 1200A that, when selected, advances GUI 1200A to a different configuration.

Referring to FIG. 12B, an embodiment of a mobile internet GUI 1200B is displayed. In many embodiments, GUI 1200B can comprise item image 1203, item description 1204, item notification 1205, and/or add to cart button 1206. In the same or different embodiments, GUI 1200B can be accessed after selecting a search result displaying a product of a set of search results (not shown). In some embodiments, item description 1204 can comprise a textual description of an item for sale on an eCommerce website. In the same or different embodiments, item description 1204 can comprise an item title. In various embodiments, item notification 1205 can be shown when an item shown in item image 1203 and/or described in item description 1204 is determined by qualification system 406 (FIG. 4) to be eligible to be received by a user by user pick-up. In the same or different embodiments, add to cart button 1206 can comprise a selectable element on GUI 1200B that, when selected, advances GUI 1200B to a different configuration.

Referring to FIG. 12C, an embodiment of a mobile internet GUI 1200C is displayed. In many embodiments, GUI 1200C can comprise item image 1203, item description 1204, first cost with shipping indicator 1207, first cost with user pick-up indicator 1208, user pick-up availability indicator (now shown), second cost with shipping indicator 1210, second cost with user pick-up indicator 1211, and/or checkout button 1212. In some embodiments, GUI 1200C can be generated after a user selects add to cart button 1206 (FIG. 12B). In various embodiments, first cost with user pick-up indicator 1208, user pick-up availability indicator (now shown), and/or second cost with user pick-up indicator 1211 can be shown when an item shown in item image 1203 and/or described in item description 1204 is determined by qualification system 406 (FIG. 4) to be eligible to be received by a user by user pick-up. In the same or different embodiments, first cost with shipping indicator 1207 can display a home delivery retail price as described above plus a local tax amount. In various embodiments, first cost with user pickup indicator 1208 can display a user pick-up discounted retail price as described above and/or a difference of the home delivery retail price and the user pick-up discounted retail price as described above plus a local tax amount. In many embodiments, a user pick-up availability indicator (now shown) can comprise text or images configured to inform a user that an item is eligible for reception by user pick-up. In this way, users can be informed that an item is eligible for reception by user pick-up, and therefore by more likely to select this option upon checkout. In the same or different embodiments, second cost with shipping indicator 1210 can display a home delivery retail price as described above. In various embodiments, second cost with user pickup indicator 1211 can display a user pick-up discounted retail price as described above and/or a difference of the home delivery retail price and the user pick-up discounted retail price as described above. In the same or different embodiments, checkout button 1212 can comprise a selectable element on GUI 1200C that, when selected, advances GUI 1200C to a different configuration.

Referring to FIG. 12D, an embodiment of a mobile internet GUI 1200D is displayed. In many embodiments, GUI 1200D can comprise item image 1203, first cost with shipping indicator 1207, second cost with shipping indicator 1210, shipping selector 1213, pick-up selector 1214, and/or continue button 1215. In various embodiments, pick-up selector 1214 can be shown when an item shown in item image 1203 and/or described in item description 1204 is determined by qualification system 406 (FIG. 4) to be eligible to be received by a user by user pick-up. In various embodiments, shipping selector 1213, pick-up selector 1214, and/or continue button 1215 can comprise selectable user interface elements. In some embodiments, when shipping selector 1213 is selected by a user, amounts shown on first cost with shipping indicator 1207 and/or second cost with shipping indicator 1210 can be calculated, as described above, and displayed on GUI 1200D. In the same or different embodiments, when continue button 1215 is selected by a user, GUI 1200D is advanced to a different configuration.

Referring to FIG. 12E, an embodiment of a mobile internet GUI 1200E is displayed. In many embodiments, GUI 1200F can comprise item image 1203, first cost with user pick-up indicator 1208, second cost with shipping indicator 1210, shipping selector 1213, pick-up selector 1214, continue button 1215, and/or pickup savings display 1216. In various embodiments, item notification 1205 can be shown when an item shown in item image 1203 and/or described in item description 1204 is determined by qualification system 406 (FIG. 4) to be eligible to be received by a user by user pick-up. In various embodiments, pickup savings display 1216 can comprise a unit shipping cost savings as described above. In some embodiments, when pick-up selector 1214 is selected by a user, amounts shown on first cost with user pick-up indicator 1208, second cost with shipping indicator 1210, and/or pickup savings display 1216, can be calculated, as described above, and displayed on GUI 1200E. In some embodiments, elements of GUI 1200E can be displayed on a mobile application, similar to the GUIs described in FIGS. 13A-J described below. In the same or different embodiments, when continue button 1215 is selected by a user, GUI 1200D is advanced to a different configuration.

Turning now to FIGS. 13A-J, various embodiments of application GUIs configured to encourage user pick-up over home delivery of an item are shown. As an example, these internet GUIs can be mobile internet GUIs or internet GUIs configured to be shown on a display of a mobile device that is smaller than a display of a desktop computer. GUIs described in FIGS. 13A-J can be stored at memory storage device(s) 402 and/or non-transitory memory storage device(s) 403 and can be called and run at processor(s) 401, such as, for example, when the part or all of communication system 404, engagement system 405, qualification system 406, and discount system 407 cause a display to a user.

Referring to FIG. 13A, an embodiment of an internet GUI 1300A is displayed. In many embodiments, GUI 1300A can comprise selectable element 1301. In various embodiments, selectable element 1301 can be configured to apply a filter to a set of search results (not shown). In these embodiments, when selectable element 1301 is selected, individual search results of the set of search results 1302 (FIG. 13B) are removed from search results 1302 (FIG. 13B) when the individual search results do not meet requirements of a filter applied by selectable element 1301. In more specific embodiments, a filter applied when selectable element 1301 is selected can comprise displaying only items that are determined by qualification system 406 (FIG. 4) to be eligible to be received by a user by user pick-up. In the same or different embodiments, back button 1316 can comprise a selectable element on GUI 1200A that, when selected, advances GUI 1200A to a different configuration.

Referring to FIG. 13B, an embodiment of an internet GUI 1300B is displayed. In many embodiments, GUI 1300B can comprise search results 1302.

Referring to FIG. 13C, an embodiment of a mobile application GUI 1300C is displayed. In many embodiments, GUI 1300C can comprise item image 1303, item description 1304, item notification 1305, and/or add to cart button 1306. In the same or different embodiments, GUI 1300C can be accessed after selecting a search result displaying a product of a set of search results (not shown). In some embodiments, item description an can comprise a textual description of an item for sale on an eCommerce website. In the same or different embodiments, the item description can comprise an item title. Although not shown in FIG. 13C, the item description is shown as item description 1304 in FIG. 13D. Returning to FIG. 13C, in various embodiments, item notification 1305 can be shown when an item shown in item image 1303 and/or described in item description 1304 is determined by qualification system 406 (FIG. 4) to be eligible to be received by a user by user pick-up. In the same or different embodiments, add to cart button 1306 can comprise a selectable element on GUI 1300C that, when selected, advances GUI 1300C to a different configuration.

Referring to FIG. 13D, an embodiment of a mobile application GUI 1300D is displayed. In many embodiments, GUI 1300D can comprise item image 1303, item description 1304, first cost with shipping indicator 1307, first cost with user pick-up indicator 1308, user pick-up availability indicator (now shown), second cost with shipping indicator 1310, second cost with user pick-up indicator 1311, and/or checkout button 1312. In some embodiments, GUI 1300D can be generated after a user selects add to cart button 1306. In various embodiments, first cost with user pick-up indicator 1308, user pick-up availability indicator (now shown), and/or second cost with user pick-up indicator 1311 can be shown when an item shown in item image 1303 and/or described in item description 1304 is determined by qualification system 406 (FIG. 4) to be eligible to be received by a user by user pick-up. In the same or different embodiments, first cost with shipping indicator 1307 can display a home delivery retail price as described above plus a local tax amount. In various embodiments, first cost with user pickup indicator 1308 can display a user pick-up discounted retail price as described above and/or a difference of the home delivery retail price and the user pick-up discounted retail price as described above plus a local tax amount. In many embodiments, user pick-up availability indicator (now shown) can comprise text or images configured to inform a user that an item is eligible for reception by user pick-up. In this way, users can be informed that an item is eligible for reception by user pick-up, and therefore by more likely to select this option upon checkout. In the same or different embodiments, second cost with shipping indicator 1310 can display a home delivery retail price as described above. In various embodiments, second cost with user pickup indicator 1311 can display a user pick-up discounted retail price as described above and/or a difference of the home delivery retail price and the user pick-up discounted retail price as described above. In the same or different embodiments, checkout button 1312 can comprise a selectable element on GUI 1300D that, when selected, advances GUI 1300D to a different configuration.

Referring to FIG. 13E, an embodiment of a mobile application GUI 1300E is displayed. In many embodiments, GUI 1300E can comprise item image 1303, first cost with shipping indicator 1307, second cost with shipping indicator 1310, shipping selector 1313, pick-up selector 1314, and/or continue button 1315. In various embodiments, pick-up selector 1314 can be shown when an item shown in item image 1303 and/or described in item description 1304 is determined by qualification system 406 (FIG. 4) to be eligible to be received by a user by user pick-up. In various embodiments, shipping selector 1313, pick-up selector 1314, and/or continue button 1315 can comprise selectable user interface elements. In some embodiments, when shipping selector 1313 is selected by a user, amounts shown on first cost with shipping indicator 1307 and/or second cost with shipping indicator 1310 can be calculated, as described above, and displayed on GUI 1300E. In the same or different embodiments, when continue button 1315 is selected by a user, GUI 1300E is advanced to a different configuration.

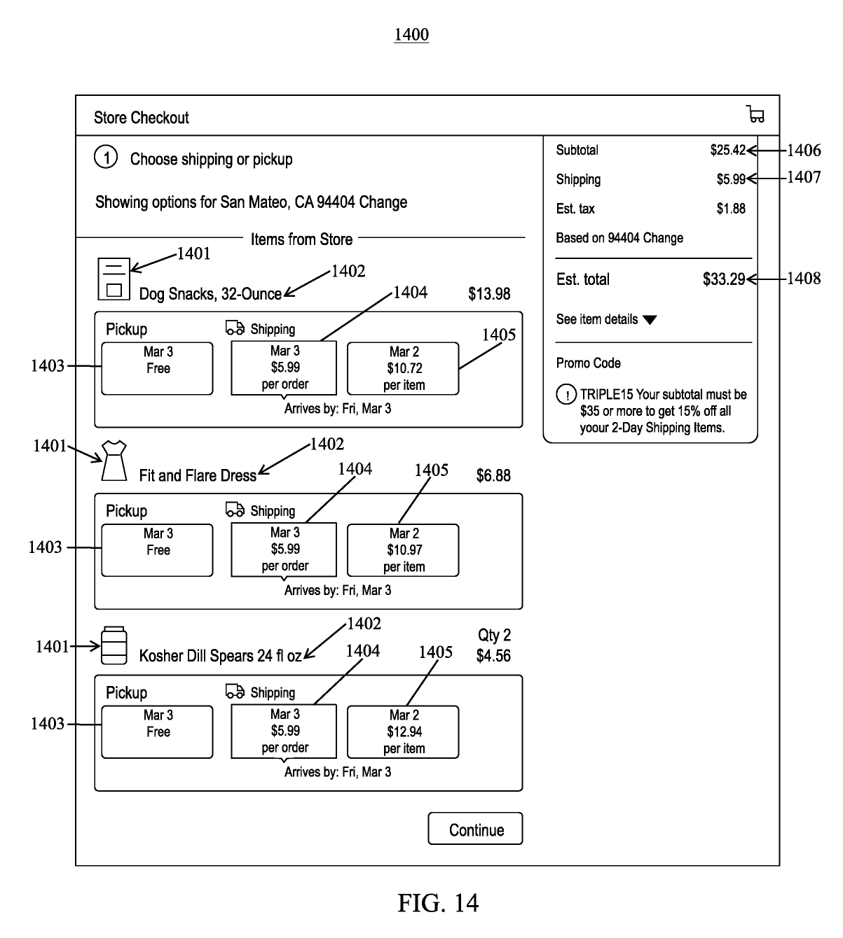

Turning now to FIG. 14, a different embodiment of a mobile GUI 1400 is displayed. GUI 1400 can be stored at memory storage device(s) 402 and/or non-transitory memory storage device(s) 403 and can be called and run at processor(s) 401, such as, for example, when the part or all of communication system 404, engagement system 405, qualification system 406, and discount system 407 cause a display to a user. In some embodiments, GUI 1400 can comprise an item image 1401, item description 1402, in-store pick-up cost 1403, first shipping cost 1404, second shipping cost 1405, subtotal 1406, shipping total 1407, and estimated total 1408. In many embodiments, GUI 1400 can be displayed after an add to cart button 1106, 1206, 1306 (FIGS. 11B, 12B, and/or 13C) and/or a check out button 1112, 1212, 1312 (FIGS. 11C, 11D, 12C, 12D, and/or 13D) is selected by a user. In some embodiments, item description 1402 can comprise a textual description of an item for sale on an eCommerce web site. In the same or different embodiments, item description 1402 can comprise an item title. In various embodiments, in-store pick-up cost 1403 can comprise a price that a retailer charges a user to pick-up an item from the store instead of having it delivered to their home. In many embodiments, in-store pick-up cost 1403 can comprise $0.00 or can be displayed as “Free.” In the same or different embodiments, first shipping cost 1404 can comprise a cost to ship an item by a later promise date. In various embodiments, second shipping cost 1405 can comprise a cost to ship an item by an earlier promise date. In many embodiments, in-store pick-up cost 1403, first shipping cost 1404, and/or second shipping cost 1405 can comprise selectable elements configured to allow a user to select a shipping speed and cost. In some embodiments, subtotal 1406 can comprise a sum of a cost of each item in an order. In various embodiments, shipping total 1407 can comprise a price comprising first shipping cost 1404 and/or second shipping cost 1405. In many embodiments, estimated total 1408 can comprise a sum of subtotal 1406, shipping total 1407, and/or a localized tax.

When compared with GUI 1400, mobile GUIs disclosed in FIGS. 12-13 allow for several technological advantages limited to computer technologies. For example, GUIs disclosed in FIGS. 12-13 are easier to operate on mobile devices for at least a number of reasons. First, shipping selector 1213, 1313 (FIGS. 12-13) and/or pick-up selector 1214, 1314 (FIG. 12-13) are easier to operate on a small screen, such as those on mobile devices, than in-store pick-up cost 1403, first shipping cost 1404, and/or second shipping cost 1405. This advantage is due to at least that shipping selector 1213, 1313 (FIGS. 12-13) and/or pick-up selector 1214, 1314 (FIGS. 12-13) are (1) span a larger portion of the screen than in-store pick-up cost 1403, first shipping cost 1404, and/or second shipping cost 1405 due to the smaller number of selectable elements displayed and (2) selecting at least one of shipping selector 1213, 1313 (FIGS. 12-13) and/or pick-up selector 1214, 1314 (FIGS. 12-13) applies that option to multiple items in an electronic shopping cart, thereby allowing a user to more efficiently navigate through a mobile GUI. Textual elements of GUIs displayed in FIGS. 12-13, such as item description 1204 (FIG. 12), first cost with shipping indicator 1207 (FIG. 12), first cost with user pick-up indicator 1208 (FIG. 12), second cost with shipping indicator 1210 (FIG. 12), second cost with user pick-up indicator 1211 (FIG. 12), and/or checkout button 1212 (FIG. 12) are configured to span larger portions of a smaller screen, thereby making them easier to read on a mobile device with a smaller screen. Further, users are incentivized to select user pick-up more in GUIs displayed in FIGS. 12-13 because the pick-up option is displayed as a discount instead of a waiver of shipping costs.

Although the invention has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-14 may be modified, and that the foregoing discussion of certain of these embodiments does not necessarily represent a complete description of all possible embodiments. For example, one or more of the activities of the methods described herein may include different activities and be performed by many different elements, in many different orders. As another example, the elements within central computer system 301 and/or user computer system(s) 303 in FIG. 3 can be interchanged or otherwise modified.

Generally, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A system to encourage user pick-up over home delivery of an item being made available to a user for purchase, the system comprising:
one or more processors; and
one or more non-transitory memory storage devices storing computer instructions configured to run on the one or more processors and perform acts of:
causing the item to be displayed on a graphical user interface; and
when the item is to be received by the user by user pick-up, evaluating whether the item is eligible to be made available for purchase at a user pick-up discounted retail price that is less than a home delivery retail price at which the item is made available for purchase when the item is to be received by the user by home delivery.

2) The system of claim 1, wherein:
when the item is to be received by the user by user pick-up, evaluating whether the item is eligible to be made available for purchase at the user pick-up discounted retail price that is less than the home delivery retail price at which the item is made available for purchase when the item is to be received by the user by home delivery comprises:
evaluating whether the item is eligible to be received by the user by user pick-up.

3) The system of claim 1, wherein:
when the item is to be received by the user by user pick-up, evaluating whether the item is eligible to be made available for purchase at the user pick-up discounted retail price that is less than the home delivery retail price at which the item is made available for purchase when the item is to be received by the user by home delivery comprises:
evaluating whether the item is subject to a minimum advertised price limitation.

4) The system of claim 1, wherein:
when the item is to be received by the user by user pick-up, evaluating whether the item is eligible to be made available for purchase at the user pick-up discounted retail price that is less than the home delivery retail price at which the item is made available for purchase when the item is to be received by the user by home delivery comprises:
evaluating whether the item is subject to store sharing.

5) The system of claim 1 wherein the computer instructions are further configured to run on the one or more processors and perform acts of:
when the item is to be received by the user by user pick-up, determining that the item is ineligible to be made available for purchase at the user pick-up discounted retail price that is less than the home delivery retail price at which the item is made available for purchase when the item is to be received by the user by home delivery; and
preventing the graphical user interface from displaying at least one of the user pick-up discounted retail price or a difference of the home delivery retail price and the user pick-up discounted retail price.

6) The system of claim 1 wherein the computer instructions are further configured to run on the one or more processors and perform acts of:
when the item is to be received by the user by user pick-up, determining that the item is eligible to be made available for purchase at the user pick-up discounted retail price that is less than the home delivery retail price at which the item is made available for purchase when the item is to be received by the user by home delivery; and
causing the graphical user interface to display at least one of the user pick-up discounted retail price or a difference of the home delivery retail price and the user pick-up discounted retail price.

7) The system of claim 1 wherein the computer instructions are further configured to run on the one or more processors and perform an act of:
determining the user pick-up discounted retail price, wherein:
determining the user pick-up discounted retail price comprises:
calculating a package shipping cost savings as a difference in a cost to ship by home delivery a package containing the item and a cost to ship by store delivery the package containing the item.

8) The system of claim 7, wherein:
determining the user pick-up discounted retail price further comprises:
calculating the cost to ship by home delivery the package containing the item as a sum of (i) a product of an associate home delivery percentage and an associate home delivery cost per package and (ii) a product of a parcel service home delivery percentage and a parcel service home delivery cost per package; and
calculating the cost to ship by store delivery the package containing the item as a sum of (i) a product of a line-haul store delivery percentage and a line-haul store delivery cost per package and (ii) a product of a parcel service store delivery percentage and a parcel service store delivery cost per package.

9) The system of claim 7, wherein:
determining the user pick-up discounted retail price further comprises:
calculating a unit shipping cost savings as a quotient of the package shipping cost savings and a units per package value associated with the item.

10) The system of claim 9, wherein:
when the item is non-sortable, the units per package value is 1; and
when the item is sortable, the units per package value is a quotient of one divided by an average quantity of units per package in a retail tier associated with the item.

11) The system of claim 9, wherein:
determining the user pick-up discounted retail price further comprises:
calculating a user pick-up discount as a product of the unit shipping cost savings and a predetermined discount percentage.

12) The system of claim 11, wherein:
determining the user pick-up discounted retail price further comprises:
assigning a first limited user pick-up discount as a product of the home delivery retail price and a predetermined maximum retail percentage;
assigning a second limited user pick-up discount as a predetermined maximum discount; and
assigning the user pick-up discounted retail price as a difference of the home delivery retail price and a lowest value of the user pick-up discount, the first limited user pick-up discount, and the second limited user pick-up discount.

13) A method to encourage user pick-up over home delivery of an item being made available to a user for purchase, the method being implemented via execution of computer instructions configured to run at one or more processors and configured to be stored at one or more non-transitory memory storage devices, and comprising:
causing the item to be displayed on a graphical user interface; and
when the item is to be received by the user by user pick-up, evaluating whether the item is eligible to be made available for purchase at a user pick-up discounted retail price that is less than a home delivery retail price at which the item is made available for purchase when the item is to be received by the user by home delivery.

14) The method of claim 13, wherein:
when the item is to be received by the user by user pick-up, evaluating whether the item is eligible to be made available for purchase at the user pick-up discounted retail price that is less than the home delivery retail price at which the item is made available for purchase when the item is to be received by the user by home delivery comprises at least one of:
evaluating whether the item is eligible to be received by the user by user pick-up;
evaluating whether the item is subject to a minimum advertised price limitation; or
evaluating whether the item is subject to store sharing.

15) The method of claim 13 further comprising:
when the item is to be received by the user by user pick-up, determining that the item is ineligible to be made available for purchase at the user pick-up discounted retail price that is less than the home delivery retail price at which the item is made available for purchase when the item is to be received by the user by home delivery; and
preventing the graphical user interface from displaying at least one of the user pick-up discounted retail price or a difference of the home delivery retail price and the user pick-up discounted retail price.

16) The method of claim 13 further comprising:
when the item is to be received by the user by user pick-up, determining that the item is eligible to be made available for purchase at the user pick-up discounted retail price that is less than the home delivery retail price at which the item is made available for purchase when the item is to be received by the user by home delivery; and
causing the graphical user interface to display at least one of the user pick-up discounted retail price or a difference of the home delivery retail price and the user pick-up discounted retail price.

17) The method of claim 13 further comprising:
determining the user pick-up discounted retail price, wherein:
determining the user pick-up discounted retail price comprises:
calculating a package shipping cost savings as a difference in a cost to ship by home delivery a package containing the item and a cost to ship by store delivery the package containing the item.

18) The method of claim 17, wherein:
determining the user pick-up discounted retail price further comprises:
calculating a unit shipping cost savings as a quotient of the package shipping cost savings and a units per package value associated with the item.

19) The method of claim 18, wherein:
determining the user pick-up discounted retail price further comprises:
calculating a user pick-up discount as a product of the unit shipping cost savings and a predetermined discount percentage.

20) A system to encourage user pick-up over home delivery of an item being made available to a user for purchase, the system comprising:
one or more processors; and
one or more non-transitory memory storage devices storing computer instructions configured to run on the one or more processors and perform acts of:
causing the item to be displayed on a graphical user interface; and
when the item is to be received by the user by user pick-up, evaluating whether the item is eligible to be made available for purchase at a user pick-up discounted retail price that is less than a home delivery retail price at which the item is made available for purchase when the item is to be received by the user by home delivery;
after evaluating that the item is eligible, determining the user pick-up discounted retail price; and
causing the graphical user interface to display at least one of the user pick-up discounted retail price or a difference of the home delivery retail price and the user pick-up discounted retail price;
wherein:
evaluating whether the item is eligible, when the item is to be received by the user by user pick-up, to be made available for purchase at the user pick-up discounted retail price that is less than the home delivery retail price at which the item is made available for purchase when the item is to be received by the user by home delivery comprises:
evaluating whether the item is eligible to be received by the user by user pick-up;
evaluating whether the item is subject to a minimum advertised price limitation; or
evaluating whether the item is subject to store sharing; and
determining the user pick-up discounted retail price comprises:
calculating a package shipping cost savings as a difference in a cost to ship by home delivery a package containing the item and a cost to ship by store delivery the package containing the item;
calculating a unit shipping cost savings as a quotient of the package shipping cost savings and a units per package value associated with the item;
calculating a user pick-up discount as a product of the unit shipping cost savings and a predetermined discount percentage;
assigning a first limited user pick-up discount as a product of the home delivery retail price and a predetermined maximum retail percentage;
assigning a second limited user pick-up discount as a predetermined maximum discount; and
assigning the user pick-up discounted retail price as a difference of the home delivery retail price and a lowest value of the user pick-up discount, the first limited user pick-up discount, and the second limited user pick-up discount.
